(19) United States
(12) Patent Application Publication
(10) Pub. No.: US 2024/0406978 A1
(43) Pub. Date: Dec. 5, 2024

(54) METHOD FOR DETERMINING SIDELINK RESOURCE

(71) Applicant: Samsung Electronics Co., Ltd., Suwon-si, Gyeonggi-do (KR)

(72) Inventors: Miao ZHOU, Beijing (CN); Feifei SUN, Beijing (CN); Min WU, Beijing (CN)

(21) Appl. No.: 18/697,342

(22) PCT Filed: Sep. 29, 2022
(86) PCT No.: PCT/KR2022/014610

§ 371 Date: Mar. 29, 2024

(30) Foreign Application Priority Data
Sep. 29, 2021 (CN) 202111155539.0
Nov. 3, 2021 (CN) 202111295289.0

(51) Int. Cl. H04W 72/25; H04B 17/318; H04W 72/0446

(52) U.S. Cl. CPC H04W 72/25; H04B 17/328; H04W 72/0446

(57) ABSTRACT

The disclosure relates to a 5G or 6G communication system for supporting a higher data transmission rate. A method performed by a terminal in a wireless communication system is provided. The method includes determining a resource selection window (RSW) corresponding to partial sensing, determining a sensing window corresponding to the partial sensing and determining transmission resources for sidelink transmission based on the partial sensing result.

### TECHNICAL FIELD

The present application relates to the field of wireless communication technology, and more specifically, to a method for determining resources for sidelink (SL) transmission in the sidelink communication in the fifth-generation new radio access technology (5G NR) system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

According to an aspect, a method performed by a terminal in a wireless communication system. the method comprises determining a resource selection window (RSW) corresponding to partial sensing, determining a sensing window corresponding to the partial sensing and determining transmission resources for sidelink transmission based on the partial sensing result.

### BRIEF DESCRIPTION OF DRAWINGS

The above and other aspects, features, and advantages of the present disclosure will be more apparent from the following detailed description when taken in conjunction with the accompanying drawings, in which:

FIG. 1 illustrates an example wireless network according to various embodiments of the present disclosure;

FIG. 2A illustrates an example wireless transmission and reception path according to the present disclosure;

FIG. 2B illustrates an example wireless transmission and reception path according to the present disclosure;

FIG. 3A illustrates an example UE according to the present disclosure;

FIG. 3B illustrates an example gNB according to the present disclosure;

FIG. 4 is a flowchart showing a method according to an example embodiment of the present disclosure;

FIG. 5A schematically illustrates an example of an embodiment according to the present disclosure;

FIG. 5B schematically illustrates another example of an embodiment according to the present disclosure;

FIG. 5C schematically illustrates another example of an embodiment according to the present disclosure;

FIG. 5D schematically illustrates another example of an embodiment according to the present disclosure;

FIG. 6 schematically illustrates an example of an embodiment according to the present disclosure;

FIG. 7 is a diagram illustrating a structure of a UE, according to an embodiment; and

FIG. 8 is a diagram illustrating a structure of a base station, according to an embodiment.

### BEST MODE FOR CARRYING OUT THE INVENTION

Definitions of certain words and terms are given in the description of the present disclosure. Those of ordinary skill in the art should understand that, in many cases (if not in most cases), such definitions are applicable to the use of such defined words and terms in various situations in the past and in the future. Unless otherwise specified, the terms used in the present disclosure have the same meanings as understood by those of ordinary skill in the art to which the present disclosure belongs. For example, the terms of those terms defined in commonly used dictionaries should be interpreted as having the same meaning as the context in the relevant field, and should not be interpreted as having a transitional idealized or formalized meaning.

Although terms including ordinal numbers such as “first” and “second” are used to describe various elements (for example, components, steps, etc.), these elements are not limited by these terms. These terms are only used to distinguish one element from another. Therefore, these terms may be used interchangeably without departing from the scope of the present disclosure. For example, the first element may be referred to as the second element, and similarly, the second element may also be referred to as the first element. In addition, as used herein, the terms “/”, “or”, “and/or” are intended to include any and all combinations of one or more related items.

By referring to the following detailed description of the various embodiments and the accompanying drawings in the specification, the aspects and features of the present disclosure and the implementation thereof can be understood more clearly. However, the present disclosure may be embodied in many different forms, and should not be construed as being limited to the various embodiments set forth herein. Rather, these embodiments are provided to make the present disclosure full and complete, and to fully convey the principles and concepts of the present disclosure to those skilled in the art. Therefore, those of ordinary skill in the art should recognize that various modifications, adjustments, combinations and substitutions can be made to the various embodiments described in the present disclosure without departing from the spirit and scope of the present disclosure. Moreover, these modifications, adjustments, combinations and substitutions should also be considered to be included in the scope of protection of this application as defined by the claims.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window su-perposition coding (SWSC) as advanced coding modulation (ACM), and filter bank multicarrier (FBMC), non-orthogonal multiple access (NOMA) and sparse code multiple access (SCMA) as advanced access technologies have been developed.

Aspects and advantages of the disclosed embodiments will be set forth in part in the following description, or may be learned from the description, or may be learned by practice of the embodiments.

Similar to the current full sensing technology, when using periodic-based partial sensing (PBPS) and/or contiguous partial sensing (CPS) technology, it is also necessary to determine how the user equipment (UE) defines the resource selection window and the resource sensing window. In addition, when PBPS and CPS are used for a given transmission, it is also necessary to determine how to deal with the rela-tionship between the two technologies and make their cooperation effective.

The application provides a method for sensing on partial resources in a sidelink communication system when an energy saving mechanism is used in the sidelink communication system. The method is further optimized for the purpose of saving energy based on the sensing of traditional communication systems, such that UE can also sense for re-evaluation and pre-emption mechanisms when using partial sensing, and can also select a set of resources that is more suitable as candidate resources based on the current sensing result when being triggered to select resources, so as to achieve the purpose of improving the performance of current transmission and reducing the power consumption of the system.

According to an aspect of the present application, a method performed by a terminal in a wireless communication system is provided, the method comprising: determining a resource selection window (RSW) corresponding to partial sensing; determining a sensing window corresponding to partial sensing; and determining transmission resources for sidelink transmission based on the partial sensing result.

In the method, the RSW includes at least one of the following: RSW of periodic-based partial sensing PBPS and contiguous partial sensing CPS; RSW of PBPS; RSW of CPS.

The partial sensing includes periodic-based partial sensing PBPS and/or contiguous partial sensing CPS, and determining the RSW includes at least one of the following: determining based on the RSW of PBPS; determining based on that sensing window; determining based on a first predetermined threshold. The first predetermined threshold includes a threshold based on the number of candidate slots and/or a threshold based on the size of RSW.

The method further includes determining a candidate slot set within the RSW including at least Y candidate slots, wherein the candidate slots satisfy at least one of the following conditions: PBPS-based sensing results corresponding to the slot are available, CPS-based sensing results corresponding to the slot are available, PBPS-based sensing can be performed on the slot, and CPS-based sensing can be performed on the slot.

The method further includes determining a candidate slot set within the RSW including at least Y candidate slots, wherein the candidate slots are determined based on at least one of the priority corresponding to transmission, the remaining packet delay budget PDB, and the maximum and/or minimum value of the number of candidate slots.

If the transmission resources determined for the sidelink transmission correspond to re-evaluation and/or pre-emption, a candidate slot set including at least K candidate slots is determined according to at least one of the following methods: (s₀, s₁, s₂, . . . s_{K}) determining the candidate slots in the set based on at least Y candidate slots selected in the corresponding resource selection/reselection procedure; determining candidate slots in the set based on the corresponding sensing results of PBPS and/or CPS that already being available when being triggered to select/reselect resources; and determining whether a slot in RSW can be used as a candidate slot in the set based on whether PBPS-based sensing can be performed and/or CPS-based sensing can be performed for the slot in RSW.

The terminal is triggered to perform the resource selection procedure in slot n, and the RSW of the CPS is [n+T₁, n+T₂], where T₁ and T₂ are offsets, and the value of T₁ includes at least one of the following: the value of T₁ is configured by the higher layer/configured by the base station/preconfigured; the upper bound and/or lower bound of T₁ are configured by the high layer/configured by the base station/pre-configured/predefined; the upper bound and/or lower bound of T₁ are determined based on the priority and/or the remaining PDB and/or the candidate slots; and the value of T₁ or the upper bound and/or the lower bound of T₁ are determined based on the end position of the sensing window.

The partial sensing includes contiguous partial sensing CPS, and the sensing window is determined according to at least one of the following: determining based on at least one of the time point of being triggered to perform the resource selection procedure, the selected candidate slots, the time range of reserving resources in the sidelink control information SCI, and the processing delay; determining based on the configured or predefined offset, and/or a second predetermined threshold, and/or the available sensing result; and determining based on the upper bound and/or the lower bound of the value or value of the configured or predefined offset, and/or determining based on the RSW of CPS. The second predetermined threshold includes a threshold based on the number of candidate slots and/or a threshold based on the number of initialized candidate resources.

The terminal is triggered to perform the resource selection procedure in slot n. If the transmission resources determined for sidelink transmission do not correspond to re-evaluation and/or pre-emption, it is determined that the sensing window corresponding to CPS is [n+a,n+c], where a and c are offsets, wherein the value of c includes at least one of the following: the value of c is configured by the higher layer/configured by the base station/pre-configured; the upper bound and/or the lower bound of the value of c are configured by the high layer/configured by the base station/pre-configured/pre-defined; and the upper bound and/or the lower bound of the value of c are determined based on the priority and/or the remaining PDB and/or the candidate slots.

The method further includes determining transmission resources for sidelink transmission from a candidate resource set S_{A}, wherein the candidate resource set S_{A} is initialized as a set of all candidate slots, and the total number of all candidate slots is X; wherein the value of c is adjusted when X is smaller than a specific threshold, and/or when the number of candidate resources in the initialized S_{A} is smaller than a specific threshold, and/or when more than or equal to Y′ slots in the determined candidate slots that already have PBPS-based/CPS-based sensing results.

The terminal is triggered to perform the resource selection procedure in slot n. If the transmission is unpredictable, and the transmission resources determined for sidelink transmission do not correspond to re-evaluation and/or pre-emption, it is determined that the sensing window corresponding to CPS is [n+T_{A}, n+T_{B}], where T_{A} and T_{B} are offsets, and the value of T_{B} includes at least one of the following: the value of T_{B} is configured by the higher layer/configured by the base station configuration/pre-configured; the upper bound and/or the lower bound of the value of T_{B} are configured by the higher layer/configured by the base station/pre-configured/predefined; the upper bound and/or lower bound of the value of T_{B} are determined based on priority and/or remaining PDB and/or candidate slots; the value of T_{B} or the upper and/or lower bound of the value of T_{B} are determined based on the starting position of the resource selection window RSW; and the value of T_{B} or the upper bound of the value of T_{B} is determined based on the candidate resources selected by UE in the resource selection window RSW.

The values of T_{B} and/or T₁ are adjusted when the number of slots included in RSW and/or the number of candidate slots determined in RSW is smaller than a specific threshold, and/or when the number of candidate resources in the initialized candidate resource set S_{A} is smaller than a specific threshold, and/or when more than or equal to Y′ slots in the determined RSW/candidate slots already have CPS-based sensing results.

The method further includes that the partial sensing includes periodic-based partial sensing PBPS and/or contiguous partial sensing CPS; determining transmission resources for sidelink transmission includes determining transmission resources for sidelink transmission from candidate resource set S_{A}, wherein candidate resources that are not used as transmission resources are excluded from candidate resource set S_{A} according to the following method: candidate resources that are not used as transmission resources are excluded by using the contiguous partial sensing CPS-based sensing result, and if periodic partial sensing PBPS-based sensing results are available, candidate resources that are not used as transmission resources are also excluded by using the PBPS-based sensing result.

Exclude candidate resources that are not used as transmission resources based on RSRP thresholds, and the exclusion includes at least one of the following: excluding the sensing results of PBPS and CPS based on the same or different RSRP thresholds; excluding the available sensing result corresponding to PBPS/CPS when the terminal is triggered to perform the resource selection procedure in slot n and the sensing result corresponding to PBPS/CPS obtained after the slot n based on the same or different RSRP thresholds; and excluding resource selection/reselection and re-evaluation and/or pre-emption based on the same or different RSRP thresholds.

If the transmission is predictable, and the transmission resources determined for the sidelink transmission do not correspond to re-evaluation and/or pre-emption, and the partial sensing includes PBPS and CPS, the method further includes: determining that the RSW is the RSW of PBPS; determining candidate slots in the RSW based on PBPS; and determining that the sensing window is at least a sensing window corresponding to PBPS and a sensing window corresponding to CPS, wherein the sensing window corresponding to CPS is determined based on at least one of the determined candidate slots, the time range of reserving resources in SCI and the processing delay.

If the transmission is unpredictable, and the transmission resources determined for the sidelink transmission do not correspond to re-evaluation and/or pre-emption, and the partial sensing includes PBPS and/or CPS, the method further includes: determining that the RSW is the RSW of PBPS; determining candidate slots in RSW based on PBPS and/or CPS; and determining that the sensing window is at least a sensing window corresponding to PBPS and a sensing window corresponding to CPS, wherein the sensing window corresponding to CPS is determined based on at least one of the time point when the resource selection procedure is triggered, the selected candidate slots, the time range of reserving resources in SCI, and the processing delay.

If the transmission is unpredictable, and the transmission resources determined for the sidelink transmission do not correspond to re-evaluation and/or pre-emption, and the partial sensing includes contiguous partial sensing of CPS, the method further includes: determining that the RSW is at least RSW [n+T₁, n+T₂] of CPS, where T₁ is determined according to the configuration and/or according to the sensing window corresponding to CPS; determining candidate slots in RSW, including determining all resources in RSW as candidate slots; and determining that the sensing window is at least the sensing window corresponding to CPS, wherein the sensing window corresponding to CPS is determined according to configuration or predefinition and/or according to RSW of CPS.

The transmission is predictable, which means that it satisfies at least one of the following conditions: the transmission of periodic services, the non-zero resource reservation period provided when the physical layer is triggered by the higher layer to perform the resource selection procedure; and including the initial transmission and retransmission of data, or including only the initial transmission of the data, or including only the initial transmission and the first N retransmissions of the data; the transmission is unpredictable to be inconsistent with any other cases in which the transmission is unpredictable.

According to another aspect of the present application, there is provided a terminal device including a memory configured to store a computer program; and a processor configured to run the computer program to implement the method as described above.

According to another aspect of the present application, there is provided a terminal in a wireless communication system, which includes a transceiver, and a controller, which is coupled with the transceiver and configured to control to perform the above-described method.

The above and other features, aspects and advantages of various embodiments of the present disclosure will be better understood with reference to the following description and appended claims. The drawings of the specification, which form a part of this disclosure, illustrate example embodiments of this disclosure, and together with the specification, serve to explain related principles. Details of one or more embodiments of the subject matter of the present invention are set forth in the accompanying drawings of the specification and the following description. Other potential features, aspects and advantages of the subject matter of the present invention will also become clear from these descriptions, drawings and claims.

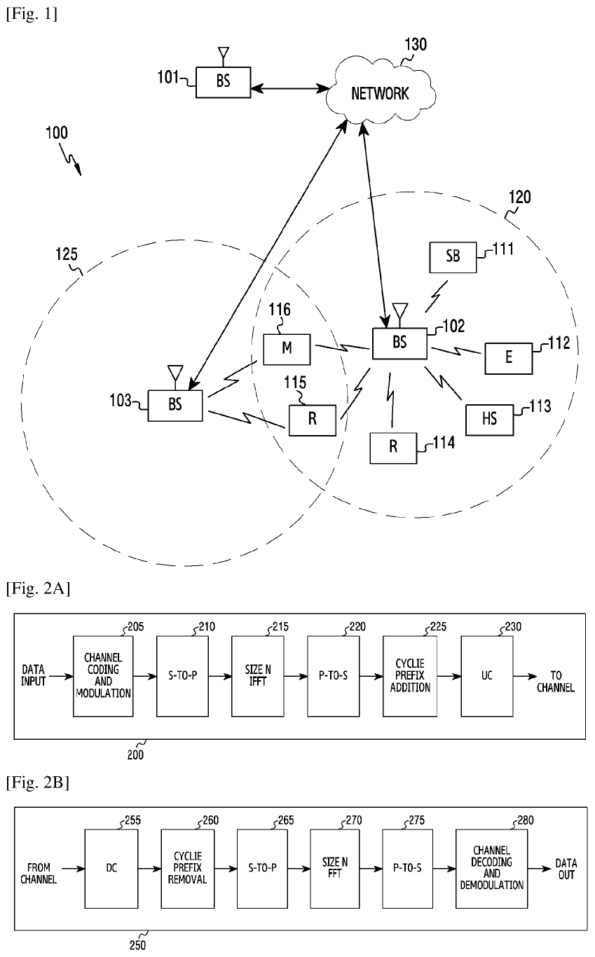

FIG. 1 illustrates an example wireless network according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio en-vironment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

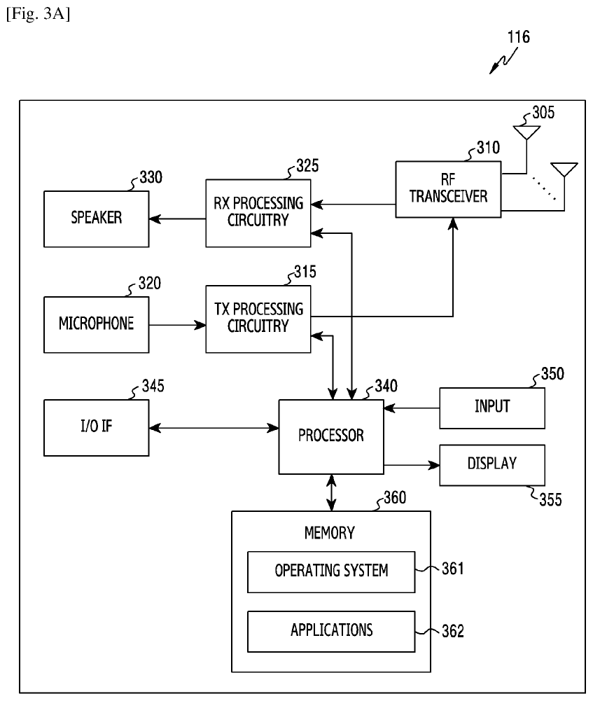

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these ac-cessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In long term evolution (LTE) technology, the sidelink communication includes two main mechanisms: Device to Device (D2D) direct communication and Vehicle to Vehicle/Infrastructure/Pedestrian/Network (collectively referred to as V2X), wherein V2X is designed on the basis of D2D technology. It is superior to D2D in terms of data rate, latency, reliability, link capacity, etc., and is the most representative sidelink communication technology in LTE technology. In 5G communication system, the sidelink communication mainly includes V2X communication.

NR V2X system defines several sidelink physical channels, including Physical Sidelink Control Channel (PSCCH), Physical Sidelink Shared Channel (PSSCH) and Physical Sidelink Feedback Channel (PSFCH). PSSCH is used to carry the data, PSCCH is used to carry Sidelink control information (SCI), the SCI indicates the time-frequency domain resource position of the associated PSSCH transmission, modulation and coding mode, receiving target ID for PSSCH and other information, and PSFCH is used to carry HARQ-ACK information corresponding to the data.

In the NR V2X system, at present, the slot in the 5G system is used as the minimum unit of time domain resource allocation, and the sub-channel is defined as the minimum unit of frequency domain resource allocation. A sub-channel is configured as several RBS in the frequency domain, and a sub-channel may include at least one resource corresponding to PSCCH, PSSCH and PSFCH.

From the perspective of resource allocation, 5G sidelink communication system includes two modes: a resource allocation mode based on base station scheduling and a resource allocation mode independently selected by UE. In 5G V2X system, the resource allocation mode based on base station scheduling is referred to as mode 1; the resource allocation mode independently selected by UE is referred to as mode 2.

For resource allocation mode 1, the method for the base station to schedule resource for the sidelink UE is to transmit a sidelink grant to the sidelink UE, and several or periodic sidelink resources used for the sidelink UE are indicated in the sidelink grant. The sidelink grant includes dynamic grant and configured grant, wherein the dynamic grant is indicated by DCI, the configured grant further includes the configured grant of type 1 and type 2, the configured grant of type 1 is indicated by RRC signaling, and the configured grant of type 2 is indicated by RRC signaling and activated/deactivated by DCI.

For resource allocation mode 2, the method for the sidelink UE to independently select resource is that the UE determines a specific time window before the sidelink transmission according to the expected time range of transmitting the sidelink transmission, and the UE performs channel sensing in the specific time window, then excludes the sidelink resources that have been reserved by other sidelink UE according to the result of channel sensing, and randomly selects from the sidelink resources which are not excluded.

In the existing technologies, UE performs channel sensing based on its buffered sidelink signals/channels received on all time-frequency resources in the sidelink resource pool. Because the UE shall not skip any monitoring on a sidelink slot (except for the case that it cannot be monitored due to the limitation of UE capability such as half duplex/receiving downlink transmission, which does not belong to the category of skipping monitoring), the power consumption for sensing is high. Therefore, if a partial sensing mechanism is introduced for the sidelink communication system, this mechanism allows the UE to perform sensing only on specific partial time-frequency resources to reduce power consumption. Partial sensing mechanism further includes two typical technologies: periodic-based partial sensing (PBPS) and contiguous partial sensing (CPS). PBPS has a periodic sensing window, which can be used to eliminate the interference caused by periodic services sent by other UEs in the resource pool. For example, the UE can detect the cross-cycle resource reservation indicated by other UEs in SCI in the periodic sensing window, and exclude the reserved resources from the candidate resource set that can be transmitted/received by the UE itself. CPS has a contiguous sensing window, which can be used to eliminate the interference caused by aperiodic services or retransmissions sent by other UEs in the resource pool. For example, the UE can detect the resource reservation in the period indicated by other UEs in SCI in the contiguous sensing window, and exclude the reserved resources from the candidate resource set that can be transmitted/received by the UE itself.

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

The slot in the embodiment of this application can be either a subframe or slot in the physical sense or a subframe or slot in the logical sense. Specifically, the subframe or slot in the logical sense is the subframe or slot corresponding to the resource pool of sidelink communication. For example, in V2X system, the resource pool is defined by a repeated bitmap, which is mapped to a specific set of slots. The specific set of slots can be all slots or all other slots except some specific slots (such as the slot for transmitting MIB/SIB). The slot indicated as “1” in the bitmap can be used for V2X transmission and belongs to the slot corresponding to V2X resource pool; the slot indicated as “0” cannot be used for V2X transmission and does not belong to the slot corresponding to the V2X resource pool.

The following is a typical application scenario to illustrate the difference between the physical or logical subframes or slots: when calculating the time domain gap between two specific channels/messages (such as PSSCH carrying sidelink data and PSFCH carrying corresponding feedback information), it is assumed that the gap is N slots. If the physical subframe or slot is calculated, the N slots correspond to the absolute time length of N*x milliseconds in the time domain, x is the time length of the physical slot (subframe) under the numerology of the scenario in millisecond; otherwise, if the subframe or slot in the logical sense is calculated, take the sidelink resource pool defined by the bitmap as an example, the gap of the N slots corresponds to the N slots indicated as “1” in the bitmap, and the absolute time length of the gap changes with the specific configuration of the sidelink communication resource pool without a fixed value.

Further, the slot in the embodiment of this application can be a complete slot or several symbols corresponding to the sidelink communication in one slot. For example, when the sidelink communication is configured to be performed on the X1-X2 symbols of each slot, the slot in the following embodiment is the X1-X2 symbols in the slot in this scenario; alternatively, when the sidelink communication is configured as mini slot transmission, the slot in the following embodiment is a mini slot defined or configured in the sidelink system rather than a slot in the NR system; alternatively, when the sidelink communication is configured as symbol level transmission, the slot in the following embodiment may be replaced with a symbol, or may be replaced with N symbols of time domain granularity as symbol level transmission.

In the embodiment of this application, the information configured by the base station, indicated by the signaling, configured by the higher layer, and pre-configured includes a group of configuration information; it also includes multiple groups of configuration information, and the UE selects a group of configuration information for use according to predefined conditions; it also includes a group of configuration information including multiple subsets, from which UE selects a subset for use according to predefined conditions.

Some of the technical solutions provided in the embodiments of this application are specifically described based on V2X system, but the application scenario thereof should not be limited to V2X system in the sidelink communication, but can also be applied to other sidelink transmission systems. For example, the design based on the V2X subchannel in the following embodiments can also be used for D2D subchannel or other sidelink transmission subchannel. The V2X resource pool in the following embodiments can also be replaced with a D2D resource pool in other sidelink transmission systems, such as D2D.

In the embodiment of this application, when the sidelink communication system is V2X system, the terminal or UE can be various types of terminals or UEs such as Vehicle, Infrastructure, Pedestrian, etc.

In order to make the objectives, technical solutions, and advantages of the present application clearer, the implementation of the present application will be further described in detail below in conjunction with the accompanying drawings.

In the embodiment of this application, lower than the threshold can also be replaced by at least one of higher than the threshold, lower than or equal to the threshold and higher than or equal to the threshold; higher than (exceeding) the threshold may also be replaced by at least one of lower than the threshold, lower than or equal to the threshold, and higher than or equal to the threshold; or vice versa

In the traditional communication system, since the DRX system mainly corresponds to PDCCH reception, it is called discontiguous reception. In the sidelink communication system, DRX mechanism can be used for the transmission and reception of UE. Correspondingly, in the embodiment of this application, DTX (discontiguous transmission) and DRX (discontiguous reception) can be replaced with each other, and the protection scope should not be affected by the different names.

The base station in this specification can also be replaced by other nodes, such as sidelink nodes. A specific example is the infrastructure UE in the sidelink system.

In this specification, the active period/inactive period of DRX configuration and the measurement window of measurement may include physical subframes and/or logical subframes, wherein the logical subframes include subframes configured for the sidelink resource pool.

In the sidelink communication system, feasible resource allocation schemes include full sensing, partial sensing, random selection, re-evaluation, pre-emption, etc. Wherein, the full sensing mainly means that UE receives and buffers all resources in the configured sidelink resources. The advantage of this method is that the sensing information collected is the most sufficient. For any sidelink transmission, the UE assumes that its corresponding sensing window has been buffered by the UE, and based on full sensing, the UE can detect as many potential conflicts as possible with other sidelink UEs; however, the power consumption caused by full sensing is high, so it is more suitable for UEs that are not sensitive to power consumption, such as vehicle nodes whose communication module has on-board power supply.

The partial sensing mainly means that the UE receives and buffers only some of the resources in the configured sidelink resources; generally, the some of the resources corresponds to the sensing window of all transmissions initiated by the UE or the sensing window of all transmissions initiated by the UE belongs to a subset of this part of the resource. The advantage of this method is that the power consumption corresponding to receiving and buffering by UE is lower, which helps UE save energy. However, compared with full sensing, if the partial sensing pursues lower power consumption, it needs to reduce the scope of detecting potential conflicts. Therefore, it is likely to sacrifice part of the performance of avoiding conflicts. In the protocol, the full sensing and the partial sensing can correspond to different sensing window calculation methods.

Further, the partial sensing/full sensing may also include periodic sensing (window) and/or contiguous sensing (window). The periodic sensing mainly refers to at least one resource in the resource selection window, and its corresponding sensing window includes periodic blocks of resources. Contiguous sensing mainly refers to the resource selection window or at least one resource in the resource selection window, and the corresponding sensing window includes at least one contiguous time window. The periodic sensing and/or the contiguous sensing may be used in combination, for example, one resource selection window or at least one resource in the resource selection window corresponds to a periodic sensing window and a contiguous sensing window; or can be used separately.

Compared with the resource allocation schemes based on sensing, the random selection mainly refers to a resource allocation scheme that is not based on sensing information (or can be partially based on sensing information). When the UE uses resource allocation based on the random selection, it usually determines the set of the candidate resources based on the related parameters such as load size of the data, arrival time, latency requirement, as well as the characteristics such as UE capability, and randomly selects the resource actually used for transmission in the set of the candidate resources. This procedure generally does not involve the exclusion of the candidate resources based on channel sensing, or it can also involve the exclusion of the candidate resources based on channel sensing, but does not introduce a dedicated sensing window. The advantage of this method is that it does not introduce the power consumption caused by channel sensing, and because this method does not require sufficient sensing results, it can be used in any scenario. In addition, due to skipping the sensing procedure, the latency of initial transmission may be lower when using this method; however, compared with the transmission based on sensing, since the random selection method cannot avoid potential conflicts with other UEs, the performance of its single transmission may be worse than that of the transmission based on sensing, resulting in performance degradation or leads to more retransmissions.

Re-evaluation and pre-emption occur after the UE selects the resource for the sidelink transmission. Re-evaluation mainly refers to when the UE has selected a resource for the sidelink transmission, and has not transmitted on this resource, and has not reserved the resource in previous transmissions, it decides to give up using the resource because it detects that conflict exists on the resource. At this time, the UE can reselect another resource for the sidelink transmission. Pre-emption is similar to re-evaluation, but it mainly means that after the UE has reserved resource for the sidelink transmission by means of signaling indication, it decides to give up using the resource because it detects that conflict exists on the resource.

In the resource allocation mode 2 in the sidelink system, if the first UE is configured to use sensing and/or partial sensing, and/or the resource pool is configured to enable sensing and/or partial sensing, when the first UE transmits a sidelink signal/channel, it may need to perform channel sensing for the transmitting behavior, and determine the resources for transmitting the sidelink signal/channel based on the sensing result. Wherein the sidelink signal/channel includes PSCCH and/or PSSCH. It should be noted that the time of the sensing behavior may be before or after the time when the first UE determines that it needs to transmit a sidelink signal/channel or is triggered by the higher layer to select resources, that is, the first UE may perform sensing in advance for potential future transmission that has not yet come, and/or the first UE may perform sensing after being triggered by the higher layer to select resources. To be distinguished from re-evaluation or pre-emption, the first UE is triggered by the higher layer to select resources, which can also be referred to as initial resource selection in this embodiment. To perform the above sensing, the first UE needs to determine the sensing window corresponding to the first resource selection.

In the resource allocation mode 2 in the sidelink system, if the first UE is configured to use re-evaluation and/or pre-emption, and/or the resource pool is configured to enable re-evaluation and/or pre-emption, when the first UE transmits a sidelink signal/channel, the first UE needs to perform re-evaluation and/or pre-emption detection before actual transmission, and may need to reselect transmission resources after re-evaluation and/or pre-emption detection; therefore, the first UE may also perform channel sensing for the re-evaluation and/or pre-emption detection and/or reselection of transmission resources, and determine whether a conflict is detected, whether the selected resources need to be released and resource reselection is triggered, and reselect resources for transmitting sidelink signals/channels based on the sensing results. To be distinguished from the resources determined when the first UE is triggered by the higher layer to select resources, the reselection of resources for transmitting sidelink signals/channels triggered based on the conflicts detected by re-evaluation and/or pre-emption can also be simply referred to as resource reselection in this embodiment. To perform the above sensing, the first UE needs to determine a sensing window corresponding to resource reselection.

In this embodiment, the behavior associated with resource reselection (for example, a certain behavior corresponding to resource reselection) and the behavior associated with re-evaluation and/or pre-emption have similar meanings, which can be replaced by each other and will not be repeated in each embodiment.

In this embodiment, the reselection of resources for transmitting sidelink signals/channels triggered based on the conflicts detected by re-evaluation and/or pre-emption can also be replaced by the reselection of resources for transmitting sidelink signals/channels triggered based on inter-UE assistance information, and the behavior associated with resource reselection can also be replaced by the behavior associated with inter-UE assistance information, and vice versa.

In the specification, the candidate slot can also be replaced by the candidate time unit, and the candidate single slot resource can also be replaced by the candidate single time unit resource, which includes a specific time length, such as several consecutive symbols.

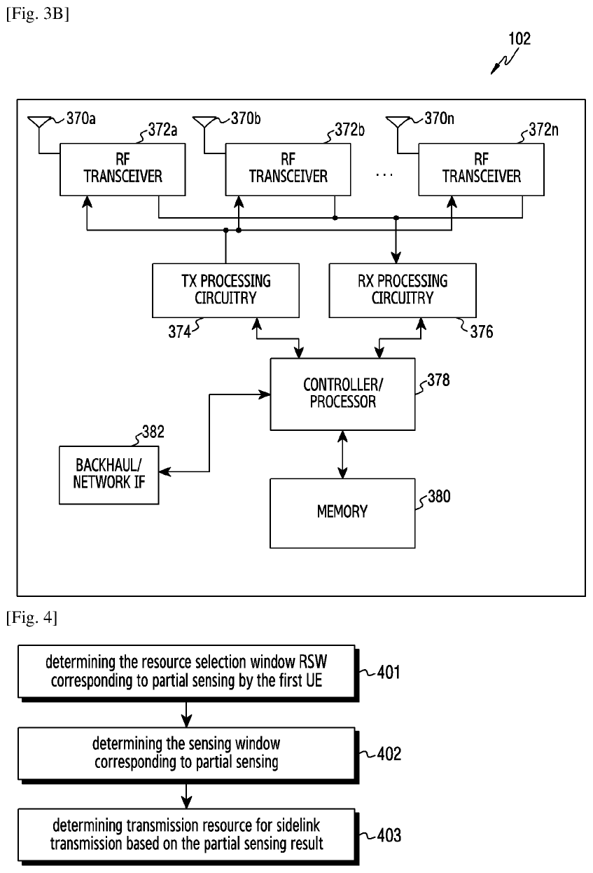

FIG. 4 is a flowchart illustrating a method according to an exemplary embodiment of the present disclosure, which includes the following steps:

Step 401: determining a resource selection window RSW corresponding to partial sensing;

Step 402: determine a sensing window corresponding to partial sensing;

Step 403: determining transmission resources for sidelink transmission based on the partial sensing result.

The RSW includes at least one of the following: RSW of periodic-based partial sensing PBPS and contiguous partial sensing CPS; RSW of PBPS; RSW of CPS. The partial sensing includes periodic-based partial sensing PBPS and/or contiguous partial sensing CPS.

### Embodiment 1

In the resource allocation mode 2 (that is, the mode in which the UE selects transmission resources independently), the higher layer of the UE, such as RRC/MAC layer, can request the physical layer to determine a subset of resources, and the higher layer may select resources for PSSCH/PSCCH transmission from the subset. The upper layer can trigger the physical layer to perform the procedure of determining the resource subset by providing parameters including resource pool, physical layer priority, and remaining packet delay budget (PDB). In this embodiment, for this scenario, a method for determining transmission resources by the physical layer of UE is explained, the method can determine a set of transmission resources for transmitting data, the set includes one or more resources. In particular, the set of transmission resources determined in this method is reported to the higher layer by the physical layer of the UE and that is used by the higher layer of the UE to select the resources for transmitting PSSCH/PSCCH transmission.

In this embodiment, the first UE is the transmitter of sidelink data, and the second UE is the receiver of sidelink data. In this embodiment, the second UE may also be replaced by one or more communication nodes, which may be a UE or a base station.

The first UE determines whether to determine transmission resources for sidelink transmission based on partial sensing according to (pre) configuration and/or preset conditions, and further determines whether to determine transmission resources for sidelink transmission based on PBPS and/or CPS if transmission resources for sidelink transmission are determined based on partial sensing. In this embodiment, the first UE determines transmission resources for sidelink transmission according to PBPS and CPS.

The first UE determines the RSW corresponding to partial sensing, determines the sensing window corresponding to partial sensing, and determines transmission resources for sidelink transmission based on partial sensing result. The determined transmission resource can be a set of transmission resources.

In this embodiment, the partial sensing includes periodic-based partial sensing PBPS and/or contiguous partial sensing CPS.

The RSW includes at least one of the following: RSW of periodic-based partial sensing PBPS and contiguous partial sensing CPS; RSW of PBPS; RSW of CPS. Wherein RSW of PBPS and CPS can be union or intersection of RSW of PBPS and RSW of CPS.

Alternatively, the first UE determining a RSW corresponding to partial sensing includes at least one of the following:

determining based on the RSW of PBPS; determining based on the sensing window; determining based on a first predetermined threshold.

It further includes: when corresponding to re-evaluation and/or pre-emption, the first UE determines a RSW1 of partial sensing, the RSW1 is determined based on RSW2, and RSW2 includes the RSW determined by the UE when not corresponding to re-evaluation and/or pre-emption. Alternatively, RSW2 and RSW1 correspond to different transmissions of the same signal/channel, for example, correspond to the initial transmission of a certain TB and the retransmission of the TB based on re-evaluation and/or pre-emption respectively.

Alternatively, the first UE determines the sensing window corresponding to partial sensing, including determining according to at least one of the following:
determining based on at least one of the time point when the resource selection procedure is triggered, the selected candidate slots, the time range of the reserved resources of the sidelink control information SCI, and the processing delay;
based on the configured or predefined offset, and/or a second predetermined threshold, and/or the available sensing result; and
based on the value of the configured or predefined offset or the upper bound and/or the lower bound of the value, and/or based on the RSW of CPS.

Wherein the sensing window includes the sensing window corresponding to CPS and/or the set of sensing occasions corresponding to PBPS.

Wherein the processing delay can be determined through the remaining PDB, and the transmission resource selected by the UE needs to be earlier than the remaining PDB corresponding to the transmission in time domain.

The first UE determines transmission resources for sidelink transmission, including determining transmission resources for sidelink transmission from a candidate resource set S_{A}, wherein candidate resources that are not used as transmission resources are excluded from the candidate resource set S_{A} according to the following method:

candidate resources that are not used as transmission resources are excluded according to the contiguous partial sensing CPS-based sensing results, and if periodic-based partial sensing PBPS-based sensing results are available, candidate resources that are not used as transmission resources are also excluded according to the PBPS-based sensing results.

Wherein the candidate resources that are not used as transmission resources are excluded based on the RSRP threshold, and the exclusion includes at least one of the following: the sensing results of PBPS and CPS are excluded based on the same or different RSRP thresholds; the available sensing results corresponding to PBPS/CPS when the terminal is triggered to perform the resource selection procedure in slot n and the sensing results corresponding to PBPS/CPS obtained after the slot n are excluded based on the same or different RSRP thresholds; and resource selection/reselection and re-evaluation and/or pre-emption are excluded based on the same or different RSRP thresholds.

Alternatively, the first UE determines the set of transmission resources according to PBPS and CPS, including the first UE selecting at least one of the above methods for determining the set of transmission resources according to the used partial sensing scheme including PBPS, or CPS, or PBPS and CPS, and/or the predictability of transmission, and/or whether the transmission corresponds to re-evaluation and/or pre-emption.

In the example of this embodiment, the predictable transmission includes at least one of the following: the transmission of periodic services, the non-zero resource reservation period provided when the physical layer is triggered by the higher layer to perform the resource selection procedure (for example, the higher layer provides P^{rsvp_TX} to the physical layer and its value is not equal to 0); further, the predictable transmission includes the initial transmission and retransmission of data (for example, one TB/packet), or only its initial transmission, or only its initial transmission and the first N retransmissions. For example, if the UE reserves at most 3 resources in SCI, the 3 resources can be used for the initial transmission and 2 retransmissions of a TB, and correspondingly, N=2. Other situations that do not meet the above conditions are considered as unpredictable transmission.

In the example of this embodiment, if the higher layer requests the UE to determine a subset of resources from which the higher layer will select resources for PSSCH/PSCCH transmission as part of the re-evaluation and/or pre-emption procedure, the higher layer provides a set of resources (r₀, r₁, r₂, . . . ) which may be subject to re-evaluation and/or a set of resources (r₀′, r₁′, r₂′, . . . ) which may be subject to pre-emption. In the example of this embodiment, the UE shall determine a set of resources S_{A} in the resource determination procedure, and if a resource rᵢ, in the set of resources (r₀, r₁, r₂, . . . ) is not a member of the set S_{A}, the UE shall report the re-evaluation of the resource rᵢ, to the higher layer; if a resource rᵢ′ in the set of resources (r₀′, r₁′, r₂′, . . . ) meets the following conditions, the UE shall report the pre-emption of the resource rᵢ′ to the higher layer:
rᵢ′ is not a member of the set S_{A}; and
rᵢ′ meets the conditions for the resource exclusion step (see step 6 in the first specific example below);
the associated priority prio_{RX} satisfies one of the following conditions: the UE is provided with the s1-PreemptionEnable parameter and its value is equal to ‘enabled’, and prio_{TX}>prio_{RX}; the UE is provided with the s1-PreemptionEnable parameter and its value is not equal to ‘enabled’, and prio_{RX}<prioₚᵣₑ and prio_{TX}>prio_{RX}.

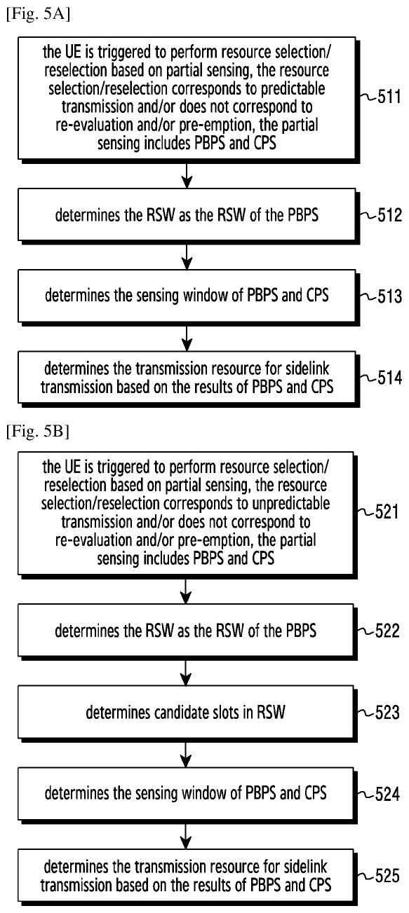

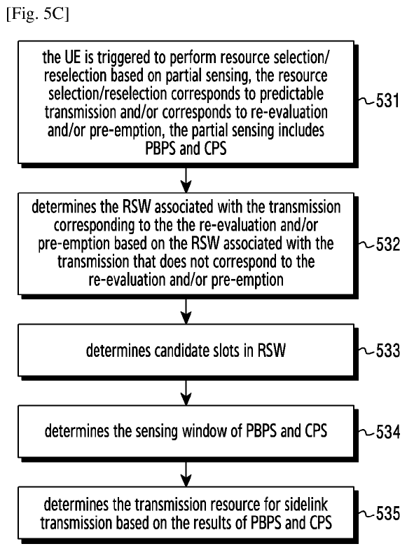

FIG. 5A schematically illustrates a specific example according to an embodiment of the present disclosure. As shown in FIG. 5A, the UE is triggered to perform resource selection/reselection based on partial sensing, resource selection/reselection corresponds to predictable transmission and/or does not correspond to re-evaluation and/or pre-emption, the partial sensing includes PBPS and CPS (511), determines the RSW as the RSW of the PBPS (512), determines the sensing window of PBPS and CPS (513), and determines the transmission resources for sidelink transmission based on the results of PBPS and CPS (514).

Specifically, in this example, the UE determines the resource selection window RSW corresponding to partial sensing, determines the sensing window corresponding to partial sensing, and determines the transmission resources for sidelink transmission based on the partial sensing result under the following conditions: the transmission is predictable; and/or, in the resource determination procedure of this example, the higher layer does not request the UE to determine the resource subset corresponding to the re-evaluation and/or pre-emption procedure, and/or does not provide the resource set corresponding to re-evaluation and/or pre-emption.

In this example, UE is triggered to select/reselect resources in slot n. In this example and the following examples, resource selection can also be replaced by resource reselection, which is not repeatedly explained in each example.

The UE determines the Resource Selection Window (RSW) [n+T₁, n+T₂] of the PBPS by using the following methods:

Selection of T₁ is up to UE implementation under 0≤T₁≤T_{proc,1}^{SL}, where T_{proc,1}^{SL} is defined in slots in Table 8.1.4-2 of 3GPP technical protocol TS 38.214, which represents the processing delay. The parameter S_{L} used in this table is the subcarrier spacing SCS configuration of the sidelink bandwidth part BWP.

If T₂ₘᵢₙ is shorter than the remaining PDB (in slots), T₂ is selected up to UE implementation subject to T₂ₘᵢₙ≤T₂≤ the remaining PDB (in slots); otherwise, T₂ is set to the remaining PDB (in slots). Wherein T₂ₘᵢₙ is configured based on the internal parameter s1-SelectionWindowList from the higher layer with a specific priority.

The UE determines candidate slots (and/or candidate single-slot resources, unless otherwise specified in this specification, both of which can be substituted for each other, and that will not be repeatedly described in each example) in RSW, specifically, determines a candidate slot set (s₀, s₁, s₂, . . . s_{Y}) including at least Y candidate slots. The UE also needs to determine the RSW of CPS. In this example, the UE determines that the RSW of CPS is the same as that of PBPS. Alternatively, for the resource selection based on PBPS and CPS, the UE uses the above method to determine that its RSW is the RSW of PBPS.

The UE shall monitor the sensing window, including: the UE should monitor the slots which belongs to a sidelink resource pool within the sensing window, except for those in which its own transmission occur. The UE shall perform the UE behavior in the following steps based on the PSCCH decoded and the RSRP measured in these slots. In this example, the UE shall monitors the sensing window corresponding to PBPS and CPS. This method can also be understood that the sensing window used by the UE for monitoring includes the union of the sensing window corresponding to PBPS and CPS. Wherein the sensing window corresponding to CPS includes [n+a, t_{y0}^{SL}−b−T_{proc,1}] or [t_{y0}^{SL}−a′, t_{y0}^{SL}−b′−T^{proc,1}], where t_{y0}^{SL} is the first slot of at least Y candidate slots selected by UE, and a and b are (pre-) configured/(pre-) defined offsets and can be positive/negative/zero, and Tproc,1 corresponds to the processing delay. For example, the values of a, a′, b, b′ can be determined based on the time range of reserved resources of SCI. If SCI indicates that at most 3 resources in 32 slots, that is, the SCI transmitted in slot m can indicate the resource located at the latest in slot m+31(since 32 slots include the slot where SCI itself is located); accordingly, if it is possible for a certain SCI to indicate the resources in the slot t_{y0}^{SL} where the selected candidate resources, the SCI is located at t_{y0}^{SL}−31 at the earliest, thereby a′ can be fixed at 31, so that the determined sensing window can cover the potential resource conflict as much as possible, and avoid to monitor the SCI that cannot reserve resources in the slot t_{y0}^{SL}, and thus reduce the power consumption in the sensing procedure. In this example, the UE determines the resource set for the predictable transmission. Because of the predictability, the UE can predict the resource selection procedure that will be triggered in the future before the slot n (for example, when periodic service is transmitted or resource selection is triggered in slot k, it can be predicted that the next slot for the transmitting the service or triggering the resource selection will be k+Pᵣₑₛₑᵣᵥₑ, where P^{reserve} is the period of the service), and sensing is performed before slot n, so the starting/ending position of the sensing window corresponding to CPS can be earlier than n, that is, t_{y0}^{SL}−a<n and/or t_{y0}^{SL}−b−T^{proc,1}<n is feasible. For another example, if the transmission that could have been predictable becomes unpredictable temporarily due to the periodic reselection of resources, and the UE fails to successfully perform the sensing before the slot n, the sensing window corresponding to the CPS after the slot n, such as [n+a, t_{y0}^{SL}−b−T_{proc,1}] where a=1, can also be used, so that the UE can perform the sensing as early as possible after being triggered by the resource selection procedure and reduce the total latency in the resource selection procedure.

The UE determines the RSRP threshold Th(pᵢ,pⱼ) used in the sensing procedure (for example, in the resource exclusion step) according to the parameters configured by the higher layer. Alternatively, PBPS and CPS use the same RSRP threshold, for example, the RSRP threshold of PBPS and the RSRP threshold of CPS are determined based on the same set of configuration parameters; or, PBPS and CPS use different RSRP thresholds, for example, the RSRP threshold of PBPS and the RSRP threshold of CPS are determined based on different configuration parameters or by using different formulas (including using different values of the same coefficient in the formula). Alternatively, when the UE is configured with more than one set of related configuration parameters, different RSRP thresholds are used; otherwise, the same RSRP threshold is used.

The UE determines transmission resources for sidelink transmission from the candidate resource set S_{A}, wherein the UE initializes the candidate resource set S_{A} to the at least Y candidate slots. The candidate resource set S_{A} can be understood to be based on PBPS and CPS. For example, the UE initializes S_{A} according to the candidate resources of CPS and RSW, that is, the same at least Y candidate slots, or it can be understood that the UE initializes the candidate resource set S_{A} corresponding to CPS as the S_{A} corresponding to PBPS.

Based on the information detected by the UE in the sensing procedure, the UE excludes resources from the candidate resource set and detects the number of resources that are not excluded, and determines whether and how to adjust the RSRP threshold based on the number, and reports the final generated candidate resource set to the higher layer.

Specifically, the UE performs the following steps to perform resource exclusion in the candidate resource set:

Step 5: If any candidate single-slot resource R_{x,y} meets all the following conditions, the UE shall exclude the candidate single-slot resource R_{x,y} from the set S_{A}:
the UE has not monitored the slot t′ₘ^{SL} when monitoring the sensing window;
for any periodicity value allowed by the higher layer parameter s1-ResourceReservePeriodList, and a hypothetical SCI format 1-A received in the slot t′ₘ^{SL} with ‘Resource reservation period’field in the SCI format set to that periodicity
value and indicating all subchannels of the resource pool in this slot, the condition c in step 6 would 1 be met.

Step 6: If any candidate single-slot resource R_{x,y} meets all the following conditions, the UE shall exclude the candidate single-slot resource R_{x,y} from the set S_{A}:
condition a: the UE receives an SCI format 1-A in the slot t′ₘ^{SL}, and ‘Resource reservation period’ field (if present), and ‘Priority’ field in the received SCI format 1-A indicates the values P_{rsvp_RX} and prio_{RX} respectively;
condition b: the RSRP measurement performed for the SCI format 1-A is higher than the RSRP threshold Th(prio_{RX},prio_{TX});
condition c: the SCI format 1-A received in the slot t′ₘ^{SL} or the same SCI format which, if and only if the ‘Resource reservation period’ field is present in the received SCI format 1-A, is assumed to be received in slot(s) t′_{m+q×P}_{_{rsvp_RX′}}^{SL}, and its determined RB set (that is, the RB set used by PSSCH) overlaps with R_{x,y+j×P}_{_{rsvp_TX′}}.

FIG. 5B schematically illustrates another specific example according to an embodiment of the present disclosure. As shown in FIG. 5B, the UE is triggered to perform resource selection/reselection based on partial sensing, the resource selection/reselection corresponds to unpredictable transmission and/or does not correspond to re-evaluation and/or pre-emption, the partial sensing includes PBPS and CPS (521), and determines the RSW as the RSW of PBPS (522), determines candidate slots in RSW (523), determines sensing window of PBPS and CPS (524), and determines transmission resources for sidelink transmission based on the results of PBPS and CPS (525).

Specifically, in this example, the UE determines the resource selection window RSW corresponding to partial sensing, determines the sensing window corresponding to partial sensing, and determines the transmission resources for sidelink transmission based on the partial sensing result under the following conditions: the transmission is unpredictable; and/or, in the resource determination procedure of this example, the higher layer does not request the UE to determine the resource subset corresponding to re-evaluation and/or pre-emption procedure, and/or does not provide the resource set corresponding to re-evaluation and/or pre-emption. In this example, UE is triggered to select/reselect resource in slot n.

The UE uses the method in the first specific example to determine the resource selection window (RSW) [n+T₁, n+T₂] of PBPS. The UE also needs to determine the RSW of CPS. In this example, the UE determines that the RSW of CPS is the same as that of PBPS. Or, for the resource selection based on PBPS and CPS, the UE uses the method in the first specific example to determine that its RSW is the RSW of PBPS.

The UE determines candidate slots in the RSW, specifically, determines a candidate slot set (s₀, s₁, s₂, . . . s_{Y}) including at least Y candidate slots. Wherein the candidate slot satisfies at least one of the following conditions: (in slot n) a PBPS-based sensing results corresponding to the slot are available, CPS-based sensing results corresponding to the slot are available, PBPS-based sensing can be performed on the slot, and CPS-based sensing can be performed on the slot. In addition, the candidate slots are determined based on at least one of the priority corresponding to transmission, the remaining PDB, and the maximum and/or minimum value of the number of candidate slots.

Wherein PBPS/CPS-based sensing results corresponding to the slot are available, including that the UE has sensed and obtained the sensing result and/or cached the received sidelink signal/channel on the PBPS/CPS-based sensing window corresponding to the slot; further, including that the UE has already sensed and obtained the sensing result and/or cached the received sidelink signal/channel on the subset of the PBPS/CPS-based sensing window corresponding to the slot, wherein the number of slots included in the subset or the percentage of the subset occupied the PBPS/CPS-based sensing window complies to a specific threshold range (the threshold ranges of PBPS and CPS may be the same or different). For example, for a certain slot t in RSW, assume that its corresponding PBPS-based sensing window includes 10 slots in total, t−P1, t−P2, . . . T−P10, and its corresponding CPS-based sensing window includes no more than 31 slots in total, [t−31, t−1); and it is assumed that the UE has sensed on no less than 50% of the slots on the PBPS/CPS-based sensing window before it can be considered that PBPS/CPS-based sensing results corresponding to the slot are available; if the UE has sensed on slots t−P10, t−P9 and [t−20, t−1), the UE determines that there are CPS-based sensing result and no PBPS-based sensing results corresponding to the slot t.

Wherein the above-mentioned slot on which PBPS/CPS-based sensing can be performed, including that there is a sufficient interval between the slot and the time point when the UE is triggered to perform the resource selection procedure in order to perform PBPS/CPS after the time point when the UE is triggered to perform the resource selection procedure. Wherein whether the time interval is sufficient, including whether the length of the interval exceeds a threshold, the threshold can be determined based on at least one of following: (pre) configuration/(pre) definition; the value of periodic Pᵣₑₛₑᵣᵥₑ enabled in the resource pool and/or used in the resource selection procedure; the (minimum) length of the CPS window corresponding to the transmission; the physical layer priority corresponding to the transmission; the remaining PDB corresponding to the transmission. Whether the time interval is sufficient, further including: whether the number of slots overlapping with the PBPS/CPS-based sensing window corresponding to the slot exceeds a specific threshold, and/or whether the percentage of the overlapping slots in the sensing window exceeds a specific threshold. For example, the UE may be (pre-) configured or (pre-) defined with the minimum window length of CPS of the service under a specific priority, then when the interval between the slot and the time point when the UE is triggered to perform the resource selection procedure is greater than or equal to the minimum window length (or the minimum window length plus UE processing delay), the UE determines that the slot on which CPS-based sensing can be performed.

The above conditions about the available sensing results and the sensing that can be performed can be further combined, including whether the sum of the available sensing results corresponding to the slot and the sensing that can be performed in the slot exceeds the threshold. For example, for a certain slot t in RSW, if the UE has sensed in a slot or a % of slots in its corresponding PBPS-based sensing window, and there is an overlap of b slots or b % of slots between the corresponding sensing window and the time point when the UE is triggered to perform the resource selection procedure (that is, the UE is allowed to perform PBPS-based sensing in b slots in the interval), then when a+b exceeds a specific threshold, the slot is considered to satisfy at least one of the above specified conditions

Alternatively, the above conditions are used to judge whether the resources in the RSW can be used as candidate slots, and/or the priority of selecting candidate slots. Using the above conditions to judge the priority of selecting candidate slots includes judging at least one of the following:
which slots are preferentially selected as candidate slots;
the resources on which slots are preferentially selected as candidate resources (for example, selecting which slots are included in the candidate resource set S_{A} reported to the higher layer);

(Alternatively, in the candidate resource set,) the resources on which slots are preferentially selected as transmission resources for sidelink transmission.

Alternatively, the method of using the above conditions to determine which slots are preferentially selected as candidate slots includes: the candidate slots selected by the UE can be the union of slots that satisfy any one of the above conditions or a specific one/several conditions, or slots that satisfy a specific number of the above conditions (that is, the intersection of slots that satisfy any one or a specific one/several conditions). UE selects resources in RSW as candidate slots in priority order until enough candidate slots are selected (for example, the number of selected slots exceeds the minimum value of Y).

For example, for a certain slot within RSW, when it satisfies at least one of the above conditions, the slot can be used as a candidate slot; or, for a certain slot within RSW, when it satisfies the above conditions (it can be a specific combination, for example, corresponding PBPS-based sensing results are available and CPS-based sensing can be performed or CPS-based sensing results are available), the slot can be used as a candidate slot. For another example, there is a predetermined priority order among different conditions, for example, the priority of the existence of corresponding PBPS/CPS-based sensing results has higher priority than that the PBPS/CPS-based sensing can be performed; when corresponding PBPS/CPS-based sensing results are available on n1 slots, and PBPS/CPS-based sensing can be performed on another n2 slots, the UE preferentially selects the n1 slots as candidate slots, and if enough Y candidate slots cannot be selected, continues to select the n2 slots as candidate slots. For another example, the slots that satisfy more conditions have higher priority order; for example, assuming that corresponding PBPS and CPS sensing results are available and the PBPS and CPS-based sensing can be performed in slot t1, corresponding PBPS sensing results are available and the PBPS-based sensing can be performed in slot t2, and corresponding PBPS and CPS sensing results are available in slot t3, and the CPS-based sensing can be performed in slot t4, the priority order for UE to select candidate slots is: t1>t2=t3>t4; further, if there is a priority among the conditions, including that the existence of corresponding PBPS/CPS-based sensing result has higher priority than that the PBPS/CPS-based sensing can be performed, then the priority of the UE to select the candidate slot is t1>t2>t3>t4.

For another example, if the UE determines a sensing window [n+T_{A}, n+T_{B}), the sensing window can be understood as performing the sensing corresponding to CPS within the RSW; then, the UE selects the slot in RSW after slot n+T_{B} and having the corresponding PBPS-based sensing result as the candidate slot; if enough candidate slots cannot be selected, continues to select other slots after the slot n+T_{B} in the RSW as candidate slots, and/or select slots after the slot n+T_{B} in the RSW on which PBPS-based sensing can be performed as candidate slots. Alternatively, when the remaining PDB is greater than a specific threshold, in this example, the sensing window [n+T_{A}, n,+T_{B}) is determined and the above method is adopted; alternatively, when the remaining PDB is smaller than a specific threshold, the UE preferentially selects the slot in RSW and having the corresponding PBPS/CPS-based sensing result as the candidate slot, and does not determine the sensing window [n+T_{A}, n+T_{B}).

Alternatively, the method of using the above conditions to preferentially select the resources on which slots are used as transmission resources for sidelink transmission, and/or the method of preferentially selecting the resources on which slots are used as candidate resources includes preferentially selecting based on at least one of the following:
for a certain candidate resource (for example, any candidate single slot resource in the candidate resource set S_{A}), when the slot in which it is located satisfies at least one of the above conditions, the slot (compared with other slots that do not satisfy any of the above conditions) has a higher priority, and/or this candidate resource (compared with other candidate resources on other slots that do not satisfy any of the above conditions) has a higher priority;
there is a predetermined priority order among different conditions, the slots satisfying the conditions for higher priority order have higher priority, and/or the candidate resources on the slots satisfying the conditions for higher priority order have higher priority;
slots satisfying more conditions have higher priority, and/or candidate resources on slots satisfying more conditions have higher priority;
for the condition that PBPS/CPS-based sensing results corresponding to the above conditions are available, the slots with more PBPS/CPS-based sensing results have a higher priority, and/or candidate resources on slots with more PBPS/CPS-based sensing results have higher priority.

Alternatively, the priority-based preference includes at least one of the following methods:
the UE selects the candidate resources/slots in the order of priority from high to low, so the candidate resources with higher priority and/or the candidate resources on the slots with higher priority will always be preferentially selected;
when UE selects candidate resources, candidate resources with higher priority and/or candidate resources on slots with higher priority have a greater probability of being selected.

In addition, due to the selection of transmission resources, the UE may select at most one candidate resource in each candidate slot to avoid simultaneous transmission of multiple bypass signals/channels subject to power control and UE capability. Therefore, the UE shall select one candidate resource in the slot with the highest priority, the second candidate resource in the slot with the second highest priority, and so on until enough candidate resources are selected.

The following will be explained with specific examples. For example, the UE determines the candidate resource set S_{A}, S_{A} includes candidate resources r1, r2, r3 on slot K1, candidate resource r4 on slot K2, candidate resources r5, r6 on slot K3 and candidate resources r7, r8 on slot K4. It is assumed that the corresponding sensing window of PBPS of each slot includes 10 slots in total, t−P1, t−P2, . . . T−P10, and its corresponding CPS-based sensing window includes slots [t−31, t−1], no more than 31 slots in total, where t can be K1, K2, K3, K4. In the PBPS/CPS-based sensing window corresponding to K1, K2, K3 and K4, the UE has perform CPS-based sensing on 5, 10, 20 and 0 slots respectively, and has performed PBPS-based sensing on 10, 0, 10 and 0 slots respectively, and can perform CPS-based sensing on 0, 10, 0 and 0 slots respectively.

A method for selecting candidate resources is: based on the criterion that the slots with more PBPS/CPS-based sensing results have higher priority, the UE determines the priority of slots and candidate resources as K3 (10+20 in total)>K2 (10+10 in total)>K1 (10+5 in total)>K4 (0 in total, which does not meet any of the above conditions), and determines {r5, r6}>{r4}>{r1, r2, r3}>{r7, r8}. The UE needs to select 3 transmission resources for sidelink transmission in total. The UE selects {r5, r6}, {r4}, {r1, r2, r3} in order of priority, then randomly selects r2 among r1, r2, r3, and randomly selects r5 among {r5, r6}. Finally, the selected transmission resources are {r2, r4, r5}.

Another method of selecting candidate resources is: the UE selects slots and candidate resources based on probability, and slots/candidate resources with higher priority have higher probability to be selected. Based on this criterion, the UE determines the reference probability p when any of the above conditions are not satisfied, and the probability of slot with PBPS-based sensing results/slot on which PBPS-based sensing can be performed is added to n*alpha1*p, and the probability of slot with CPS-based sensing results/slot on which CPS-based sensing can be performed is added to n*alpha2*p, where n corresponds to any one or sum of the number of slots for which PBPS/CPS-based sensing results are already available and the number of slots on which PBPS/CPS-based sensing can be performed corresponding to the slot, alpha1 and alpha2 are scaling factors corresponding to PBPS and CPS, respectively. The UE determines that the probabilities of candidate resources on K1, K2, K3 and K4 to be selected are: p+10*alpha1*p+5*alpha2*p, p+20*alpha2*p, p+10*alpha1*p+20*alpha2*p, p. The UE selects candidate resources as transmission resources based on the above probability.

Alternatively, if the UE still fails to select enough candidate slots after selecting all the resources that can be judged as candidate slots according to the above conditions, at least one of the following is performed: selecting slots that do not satisfy any of the above conditions or a specific combination of the above conditions as candidate slots; suspending the resource selection procedure based on partial sensing; adjusting the start and/or end position of RSW; adjusting at least one of the arbitrary thresholds corresponding to the above conditions (for example, a, b, or a+b in one of the above examples).

Alternatively, if the UE still fails to select enough candidate slots after selecting the slots with corresponding PBPS/CPS-based sensing results as candidate slots, the UE does not determine the candidate slots, but uses the method in Embodiment 2 to determine a sensing window [n+T_{A}, n+T_{B}) after the slot n, and determines the resource selection window RSW [n+T₁, n+T₂], and determines transmission resources for sidelink transmission within RSW according to the CPS-based results in RSW.

The UE shall monitor the sensing window, including: the UE should monitor the slots which belongs to a sidelink resource pool in the sensing window, except for those in which its own transmission occur. The UE shall perform the UE behavior in the following steps based on the PSCCH decoded and the RSRP measured in these slots. In this example, the UE shall monitor the sensing window corresponding to PBPS (or sensing window based on PBPS) and the sensing window corresponding to CPS (or sensing window based on CPS). This method can also be understood that the sensing window used by the UE for monitoring include the union of sensing windows corresponding to PBPS and CPS. Alternatively, for the candidate slot with PBPS/CPS-based sensing results, the sensing results can be considered as obtained by the UE monitoring the sensing window corresponding to PBPS/CPS. For example, the UE monitors slots Y0, Y1, Y2, . . . Yn in the resource selection procedure of TB1; if the sensing window corresponding to the PBPS of the candidate slot t selected by the UE in the resource selection procedure of TB2 includes slots Y1 and Y2, the UE considers that PBPS-based sensing results are available in slots Y1 and Y2, and multiplex the information detected in slots Y1 and Y2 in the resource selection procedure of TB2; if the sensing window corresponding to CPS of the candidate slot t includes slots y3 and y4, and the UE has not monitored slots Y3 and Y4, the UE monitors slots Y3 and Y4 for CPS-based sensing.

In this example, alternatively, the sensing window corresponding to CPS includes [n+a, t-b-T_{proc,1}], or [t_{y0}^{SL}−a′, t_{y0}^{SL}−b′−T_{proc,1}], or [max(n+a, t_{y0}^{SL}−a′), t_{y0}^{SL}−b′−T_{proc,1}], where max(n+a, t_{y0}^{SL}−a′) represents the maximum value in (n+a, t-a′), where t is the first slot of Y candidate
slots selected by the UE, the values of a, a′, b, b′ can be determined based on the time range of reserved resource of SCI, and the method is similar to that in the first specific example. Alternatively, the UE is triggered to perform the resource selection procedure in slot n. If the transmission resources determined for sidelink transmission do not correspond to re-evaluation and/or pre-emption, it is determined that the sensing window corresponding to CPS is [n+a,n+c], where a and c are offsets determined according to (pre) configuration/(pre) definition. The value of c includes at least one of the following:
the value of c is configured by the higher layer/configured by the base station/pre-configured, and further, is configured based on specific parameters including priority and/or remaining PDB; for example, the higher layer configures a corresponding value of c for each priority or several priorities;
the upper bound and/or the lower bound of the value of c are configured by the higher layer/configured by the base station/pre-configured/pre-defined, and further, are configured based on specific parameters including priority and/or remaining PDB; for example, according to the pre-definition, c is smaller than or equal to 32 or 31, and the maximum span of time domain corresponding to the reserved resources in the period indicated by SCI is 32 slots; for another example, the higher layer configures a corresponding upper bound and/or lower bound of the value of c for each priority or several priorities;
the upper bound and/or the lower bound of the value of c are determined based on the priority and/or the remaining PDB and/or the candidate slots; further, it includes determining according to the position of the earliest slot in the candidate slots and/or the minimum number of candidate slots; for example, if the remaining PDB corresponding to transmission is t_{PDB}, and the minimum number of candidate slots corresponding to transmission is n candidate, the upper bound of the value of c is t_{PDB-ncandidate-Tproc,2}, where T_{proc,2} corresponds to the processing delay of UE.

The UE determines the RSRP threshold Th(pᵢ,pⱼ) used in sensing procedure (for example, in the resource exclusion step) according to the parameters configured by the higher layer. Alternatively, PBPS and CPS use the same RSRP threshold, for example, the RSRP threshold of PBPS and the RSRP threshold of CPS are determined based on the same set of configuration parameters; alternatively, PBPS and CPS use different RSRP thresholds. For example, the RSRP threshold of PBPS and the RSRP threshold of CPS are determined based on different configuration parameters or by using different formulas (including using different values of the same coefficient in the formula); alternatively, when the UE is configured with more than one set of related configuration parameters, different RSRP thresholds are used; otherwise, the same RSRP threshold is used. Alternatively, the sensing result corresponding to PBPS/CPS already being available in slot n and the sensing result corresponding to PBPS/CPS obtained after slot n use the same RSRP threshold Th(pᵢ,pⱼ) or use different RSRP thresholds. The method of determining the same/different RSRP thresholds is similar to the above.

The UE determines transmission resources for sidelink transmission from the candidate resource set S_{A}, wherein the UE initializes the candidate resource set S_{A} to the at least Y candidate slots. This candidate resource set S_{A} can be understood to be based on PBPS and CPS. For example, the UE initializes S_{A} according to the candidate resources of CPS and RSW, that is, the same at least Y candidate slots, or it can be understood that the UE initializes the candidate resource set S_{A} corresponding to CPS as the S_{A} corresponding to PBPS.

In the above example, according to the common procedure of sensing, the UE needs to sense the at least Y candidate slots before the determined at least Y candidate slots, because the sensing made after the first slot of the at least Y candidate slots starts does not belong to the sensing corresponding to the resource selection/reselection procedure, but belong to the sensing corresponding to the re-evaluation/pre-emption procedure. Therefore, when the sensing window corresponding to CPS includes [n+a,n+c], the earliest start position of the at least Y candidate slots cannot be earlier than the slot n+c; in addition, due to the restriction of the remaining PDB, the earliest start position of the at least Y candidate slots cannot be later than the remaining PDB. Therefore, the value of c will affect the number of available at least Y candidate slots.

Alternatively, there are X candidate slots in total, and when X is smaller than a specific threshold, and/or when Y (or the upper bound of Y, which is not repeated) is smaller than a specific threshold, and/or when the number of candidate resources in the initialized S_{A} (or the upper bound of the number, which is not repeated) is smaller than a specific threshold, the UE adjusts the value of c. For example, the UE determines that the upper bound of Y is t_{PDB-c} according to the sensing window [n+a,n+c] corresponding to CPS and the remaining PDBs (referred to as t_{PDB}). If t_{PDB-c} is smaller than a specific threshold, the UE reduces the value of c by a specific value or percentage, such as reducing the value of c to c-c′, and then repeats the above procedure; if the adjusted Y is still smaller than the specific threshold, reduce the value of c by a specific value or percentage again, and so on until Y is greater than or equal to the specific threshold or c=a (for example, c=a=0 or c=a=1). The specific threshold and/or the specific value/percentage of reduction can be configured by the higher layer/configured by the base station/pre-configured/pre-defined, and further, it is configured based on specific parameters including priority and/or remaining PDB.

In the above example, because the UE can select the slots with PBPS/CPS-based sensing results as the candidate slots, it is possible for the UE to acquire enough candidate slots with the PBPS/CPS-based sensing results in RSW. At this time, the UE can adjust the sensing window of the resource selection procedure and reduce the size of the sensing window to further reduce its power consumption.

Alternatively, when more than or equal to Y′ slots among the candidate slots selected by the UE already have PBPS/CPS-based sensing results, the UE adjusts the value of c. A typical scenario is that when Y′=Y, the UE can adjust c to c=a, and the logical meaning of c=a is that the UE does not monitor the CPS-based sensing window. In another scenario, when more than or equal to Y′ slots among the candidate slots selected by the UE already have PBPS/CPS-based sensing results, the UE reduces the value of c to c-c′, where the value of c′ can be determined based on Y′, for example, a larger value of Y′ corresponds to a larger value of c′. Further, the Y′ slots can be the first Y′ slots, that is, when the first Y′ slots among the candidate slots selected by the UE already have the PBPS/CPS-based sensing results, the UE reduces the value of c to c-c′.

Based on the information detected in the sensing procedure, the UE uses the method similar to that in the first specific example to exclude resources from the candidate resource set, and detect the number of resources that are not excluded, determine whether and how to adjust the RSRP threshold based on the number, and report the final generated candidate resource set to the higher layer. Alternatively, at least CPS-based sensing results are used in resource exclusion (including steps 5 and 6 in the first specific example), and PBPS-based sensing results may be additionally used if being available.

FIG. 5C schematically illustrates another specific example according to an embodiment of the present disclosure. As shown in FIG. 5C, the UE is triggered to perform resource selection/reselection based on partial sensing, the resource selection/reselection corresponds to predictable transmission, and/or corresponds to re-evaluation and/or pre-emption, partial sensing includes PBPS and CPS (531), determines the RSW associated with the transmission corresponding to the re-evaluation and/or pre-emption based on the RSW associated with the transmission that does not correspond to the re-evaluation and/or pre-emption (532), determines candidate slots in the RSW(532), determines the sensing window of PBPS and CPS (534), and determines the transmission resources used for the sidelink transmission based on the results of PBPS and CPS (535).

Specifically, in this example, the UE determines the resource selection window RSW corresponding to partial sensing, determines the sensing window corresponding to partial sensing, and determines the transmission resources for sidelink transmission based on the partial sensing result under the following conditions: the transmission is predictable; and/or, in the resource determination procedure of this example, the higher layer requests the UE to determine a resource subset corresponding to the re-evaluation and/or pre-emption procedure, and/or provides a corresponding resource set for re-evaluation and/or pre-emption.

The main difference between this example and the previous two corresponding non-reevaluation/pre-emption examples is that in the example of non-reevaluation/pre-emption, the UE can estimate the position of slot n through the resource reservation period and the transmission position in the previous period, so as to estimate the position of RSW and the corresponding sensing window before slot n, thereby support monitoring the sensing window before slot n. However, for the example corresponding to re-evaluation and/or pre-emption, the position of the RSW of re-evaluation and/or pre-emption depends on the position of the candidate resources selected in the resource selection/reselection procedure, and the UE is triggered to select/reselect the resource in slot n, so it is difficult to predict the position of the selected candidate resources relatively accurate before slot n, so it is difficult to ac-curately predict the position of the RSW of re-evaluation and/or pre-emption, and the following procedure cannot simply reuse non-reevaluation and/or pre-emption mechanisms.

In this example, the UE is triggered to select/reselect resources in slot n, and the higher layer indicates the selected resources (r₀, r₁, r₂, . . . ) and/or (r₀′, r₁′, r₂′, . . . ) to the physical layer for re-evaluation and/or pre-emption. Alternatively, the higher layer transmits the indication in slot n′.

The UE determines the resource selection window (RSW) [n+T₁′, n+T₂′] of PBPS and CPS by using the method in the first specific example, where the value range of T₁′ may be the same as or different from that in the first example, for example, T₁′ is greater than t_{y0}^{SL}+T_{proc,1}, where t_{y0}^{SL} is the first slot of at least Y candidate slots selected by UE or t_{y0}^{SL} is the boundary T₁ of the RSW in the resource selection/reselection procedure determined by UE, T_{proc,1} corresponds to the processing delay of the UE. That is, when determining the RSW associated with re-evaluation and/or pre-emption, the UE determines the RSW associated with non-evaluation and/or pre-emption (non-evaluation and/or pre-emption can also be understood as the first selection/first reselection of resources) of the transmission.

The UE determines candidate slots in the RSW, specifically, determines a candidate slot set (s₀′,s₁′, s₂′, . . . s_{K}′) including at least K candidate slots. Alternatively, the UE determines according to at least one of the following methods:
determining the candidate slots (s₀′,s₁′, s₂′, . . . s_{K}′) in the set based on at least Y candidate slots selected in the resource selection/reselection procedure triggered at slot n; alternatively, for each slot sₙ (n=1,2, . . . ) of at least Y candidate slots, one or more candidate slots are selected within the slot range [sₙ+T1′, sₙ+T2′] for re-evaluation and/or pre-emption; further, if [sₙ+T1′, sₙ+T2′] corresponding to different sₙ overlap, try to select one or more slots as candidate slots in the overlapping part to reduce power consumption;
determining the candidate slots (s₀′,s₁′, s₂′, . . . s_{K}′) in the set based on the sensing results corresponding to PBPS and/or CPS that already being available when the resource selection/reselection is triggered. Specifically, for any slot in RSW, if the slot is triggered for resource selection/reselection or re-evaluation and/or pre-emption, or the UE expects that there will be sensing results corresponding to PBPS and/or CPS when the slot is triggered for resource selection/reselection or re-evaluation and/or pre-emption, the UE preferentially selects the slot as a candidate slot to reduce power consumption. A typical example is that when the UE expects that there will be sensing results corresponding to PBPS and/or CPS when the slot is triggered for resource selection/reselection or re-evaluation and/or pre-emption, the slot belongs to the candidate slot set selected by the UE in the resource selection/reselection procedure;
determining whether slots can be used as candidate slots (s₀′,s₁′, s₂′, . . . s_{K}′) in the set based on whether PBPS-based sensing and/or CPS-based sensing can be performed on the slot in RSW.

In this example, the UE monitors the sensing window corresponding to PBPS and the sensing window corresponding to CPS. This method can also be understood that the sensing window used by the UE for monitoring include the union of the sensing windows corresponding to PBPS and the sensing window corresponding to CPS. In addition, the starting position of any of the above sensing window should not be earlier than t_{y0}^{SL} where t_{y0}^{SL} is the first slot of at least Y candidate slots selected by the UE in the resource selection/reselection procedure. Therefore, the sensing window corresponding to PBPS is the intersection of a sensing occasion set t_{yr}^{SL}-k*Pᵣₑₛₑᵣᵥₑ and the slot range [t_{y0}^{SL}+T_{proc,1}, +∞], where +∞ represents positive infinity, where the specific way of determining the sensing occasion is similar to that in the procedure of resource selection/reselection; the sensing window corresponding to CPS includes [t_{y0}^{SL}+T_{proc,1}, t_{yr}^{SL}−T_{proc,2}), or [t_{yr}^{SL}−a, t_{yr}^{SL} T_{proc,2}), or [max (t_{y0}^{SL}−t_{proc,1}, t_{yr}^{SL}−a), t_{yr}^{SL}−t_{proc,2}); wherein t_{y0}^{SL} is the first slot of at least Y candidate slots selected by the UE in the procedure of resource selection/reselection, t_{yr}^{SL} is each of at least K candidate slots selected by the UE in re-evaluation and/or pre-emption, and/or t_{yr}^{SL} is the slot where (r₀, r₁, r₂, . . . ) located, wherein (r₀, r₁, r₂, . . . ) is indicated by the higher layer, or t can be replaced by the t_{yr0}^{SL}, where t_{yr0}^{SL} is first slot of at least K candidate slots selected by the UE in re-evaluation and/or pre-emption, T_{proc,1} and T_{proc,2} correspond to the processing delay of the UE. Wherein a is (pre) configured/(pre) defined offset, its value can be determined based on the time range reserved resource of SCI, the method is similar to that in the first specific example.

The UE determines RSRP threshold Th(pᵢ,pⱼ) used in the sensing procedure (for example, in the resource exclusion step) according to the parameters configured by the UE. Alternatively, the UE uses at least one of the following: PBPS and CPS use the same or different RSRP thresholds; the available sensing result corresponding to PBPS/CPS and the sensing result corresponding to the PBPS/CPS obtained later use the same or different RSRP thresholds; resources selection/reselection, re-evaluation and/or pre-emption use the same or different RSRP thresholds; the specific method is similar to the above.

The UE initialize the candidate resource set S_{A} to the at least k candidate slots. Based on the information detected in the sensing procedure, the UE uses the method similar to that in the first specific example to exclude resources from the candidate resource set, and detect the number of resources that are not excluded. Based on the number, the UE determines whether and how to adjust the RSRP threshold, and report the final generated candidate resource set to the higher layer.

FIG. 5D schematically illustrates another specific example according to an embodiment of the present disclosure. As shown in FIG. 5D, the UE is triggered to perform resource selection/reselection based on partial sensing, the resource selection/reselection corresponds to unpredictable transmission and/or corresponds to re-evaluation and/or pre-emption, partial sensing includes PBPS and CPS (541), determines the RSW associated with the transmission corresponding to re-evaluation and/or pre-emption based on the RSW associated with the transmission that does not correspond to re-evaluation and/or pre-emption (542), determines the candidate slot in the RSW (543), determines the sensing window of CPS (544), and determines the transmission resources for sidelink transmission based on the result of CPS (545).

Specifically, in this example, the UE determines the resource selection window RSW corresponding to partial sensing, determines the sensing window corresponding to partial sensing, and determines the transmission resources for sidelink transmission based on the partial sensing result under the following conditions: the transmission is unpredictable; and/or, in the resource determination procedure of this example, the higher layer requests the UE to determine a resources subset corresponding to the re-evaluation and/or pre-emption procedure, and/or provides a corresponding resource set for re-evaluation and/or pre-emption.

Due to the unpredictable transmission resource selection/reselection procedure, it is also difficult for the UE to estimate the position of RSW and the position of the corresponding sensing window before slot n. Therefore, the difference between this example and the previous two examples corresponding to non-reevaluation/pre-emption is different from that between the previous one and the non-reevaluation/pre-emption example.

In this example, the UE is triggered to select/reselect resources in slot n, and the higher layer indicates the selected resources (r₀,r₁,r₂, . . . ) and/or (r₀′, r₁′, r₂′, . . . ) to the physical layer for re-evaluation and/or pre-emption. Alternatively, the higher layer transmits the indication in slot n′.

The UE uses the method in the first specific example to determine the resource selection window (RSW) [n+T₁′, n+T₂′] of PBPS and CPS, where the value range of T₁′ is greater than t_{y0}^{SL}+T_{proc,1}, where t_{y0}^{SL} is the first slot of at least Y candidate slots selected by UE, or t_{y0}^{SL} is the boundary T₁ of RSW in the resource selection/reselection procedure determined by UE. T_{proc,1} corresponds to the processing delay of the UE. That is, the UE determines the RSW associated with re-evaluation and/or pre-emption based on the determination of the RSW associated with non-reevaluation and/or pre-emption (non-reevaluation and/or pre-emption can also be understood as the first selection/first reselection of resources) of the transmission.

The UE determines candidate slots in the RSW, specifically, determines a candidate slot set (s₀′,s₁′, s₂′, . . . s_{K}′) including at least k candidate slots. Alternatively, the UE determines according to at least one of the following methods:
determining the candidate slots (s₀′,s₁′, s₂′, . . . s_{K}′) in the set based on at least Y candidate slots selected in the resource selection/reselection procedure triggered at slot n; alternatively, for each slot sₙ(n=1, 2, . . . ) of at least Y candidate slots, one or more candidate slots are selected within the slot range [sₙ+T₁′, sₙ+T₂′] for re-evaluation and/or pre-emption; further, if [sₙ+T1′, sₙ+T2′] corresponding to different sₙ overlap, try to select one or more slots as candidate slots in the overlapping part to reduce power consumption;
determining the candidate slots (s₀′,s₁′, s₂′, . . . s_{K}′) in the set based on the sensing results corresponding to PBPS and/or CPS that already being available when the resource selection/reselection is triggered. Specifically, for any slot in RSW, if the slot is triggered for resource selection/reselection or re-evaluation and/or pre-emption, or the UE expects that there will be sensing results corresponding to PBPS and/or CPS when the slot is triggered for resource selection/reselection or re-evaluation and/or pre-emption, the UE preferentially selects the slot as a candidate slot to reduce power consumption. A typical example is that when the UE expects that there will be sensing results corresponding to PBPS and/or CPS when the slot is triggered for resource selection/reselection or re-evaluation and/or pre-emption, the slot belongs to the candidate slot set selected by the UE in the resource selection/reselection procedure;
determining whether slots can be used as candidate slots (s₀′,s₁′, s₂′, . . . s_{K}′) in the set based on whether PBPS-based sensing and/or CPS-based sensing can be performed on the slot in RSW

In this example, the sensing window corresponding to PBPS and the sensing window corresponding to CPS are similar to those in re-evaluation and/or pre-emption of predictable transmission, but preferably, only the sensing window corresponding to CPS is used in this example. This is because the unpredictable transmission of PBPS is difficult to be performed in advance, and accordingly, it is more difficult for the UE to re-evaluate and/or pre-empt the candidate slots of PBPS based on the candidate slots of PBPS in the resource selection/reselection procedure in advance.

### Embodiment 2

In this embodiment, the first UE is the transmitter of sidelink data, and the second UE is the receiver of sidelink data. In this embodiment, the second UE may also be replaced by one or more communication nodes, which may be a UE or a base station.

The first UE determines whether to determine transmission resources for sidelink transmission based on partial sensing according to (pre) configuration and/or preset conditions, and further determines whether to determine transmission resources for sidelink transmission based on PBPS and/or CPS if transmission resources for sidelink transmission are determined based on partial sensing. In this embodiment, the first UE determines transmission resources for sidelink transmission according to CPS.

The first UE determines the RSW corresponding to partial sensing, determines the sensing window corresponding to partial sensing, and determines transmission resources for sidelink transmission based on partial sensing result. Wherein the determined transmission resource can be a set of transmission resources.

In this embodiment, the partial sensing includes contiguous partial sensing CPS. The RSW includes the RSW of CPS.

Alternatively, the first UE determining RSW corresponding to partial sensing includes at least one of the following:

determining based on the sensing window; determining based on a first predetermined threshold.

It further includes: when corresponding to re-evaluation and/or pre-emption, the first UE determines RSW1 of partial sensing, the RSW1 is determined based on RSW2, and RSW2 includes the RSW determined by the UE when not corresponding to re-evaluation and/or pre-emption. Alternatively, RSW2 and RSW1 correspond to different transmissions of the same signal/channel, for example, correspond to the initial transmission of a certain TB and the retransmission of the TB based on re-evaluation and/or pre-emption respectively.

Alternatively, the first UE determining the sensing window corresponding to partial sensing, includes determining according to at least one of the following:
determining based on at least one of the time point when the resource selection procedure is triggered, the selected candidate slots, the time range of the reserved resources of the sidelink control information SCI, and the processing delay;
determining based on the configured or predefined offset, and/or a second predetermined threshold; and
determining based on the value of the configured or predefined offset or the upper bound and/or the lower bound of the value, and/or based on the RSW of CPS.

Wherein the sensing window includes the sensing window corresponding to CPS.

Wherein the processing delay can be determined through the remaining PDB, and the transmission resource selected by the UE needs to be earlier than the remaining PDB corresponding to the transmission in time domain.

In the example of this embodiment, the meaning of predictable/unexpected transmission is similar to that in Embodiment 1.

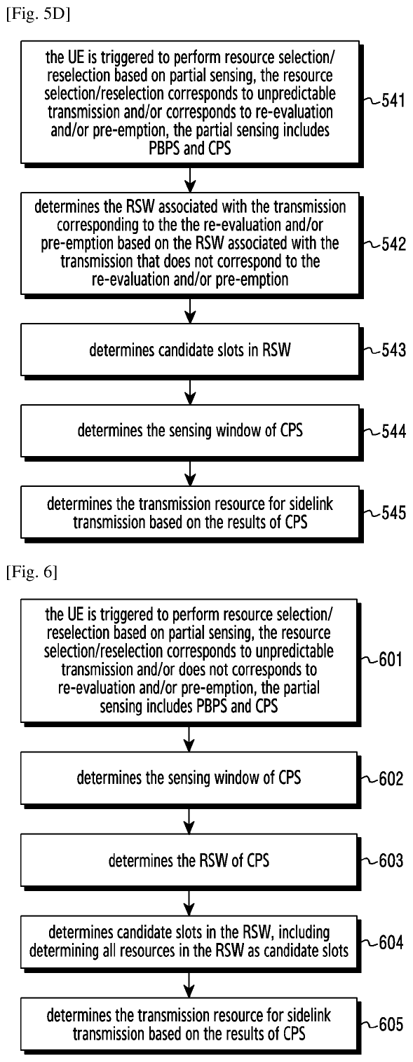

FIG. 6 schematically illustrates a specific example according to an embodiment of the present disclosure. As shown in FIG. 6, the UE is triggered to perform resource selection/reselection based on partial sensing, the resource selection/reselection corresponds to unpredictable transmission and/or does not correspond to re-evaluation and/or pre-emption, partial sensing includes CPS (601), determines the sensing window of CPS (602), and determines the RSW of CPS (603), determining candidate slots in the RSW includes determining all resources in the RSW as candidate slots (604), and determines transmission resources for sidelink transmission (605) based on the results of CPS.

Specifically, in this example, the UE determines the resource selection window RSW corresponding to partial sensing, determines the sensing window corresponding to partial sensing, and determines the transmission resources for sidelink transmission based on the partial sensing result under the following conditions: the transmission is unpredictable; and/or, in the resource determination procedure in this example, the higher layer does not request the UE to determine the resource subset corresponding to the re-evaluation and/or pre-emption procedure, and/or does not provide the corresponding resource set for re-evaluation and/or pre-emption. Alternatively, in this example, the resource pool does not support cross-cycle scheduling, for example, the higher layer parameter s1-MultiReserveResource is configured to be disabled.

In this example, UE is triggered to select/reselect resources in slot n. In this example and the following examples, resource selection can also be replaced by resource reselection, which is not repeatedly explained in each example.

The UE determines RSW [n+T₁, n+T₂] of CPS, and/or determines sensing window [n+T_{A}, n+T_{B}] corresponding to the CPS, where both T_{A} and T_{B} are offsets. Alternatively, the UE determines T₂ by using the method based on T₂ₘᵢₙ and the remaining PDB in the first specific example, but the method for determining the value of T₂ₘᵢₙ in this example is different from that in the first example, the method is: denoting the minimum value of T₂−T₁ as min_{T2-T1}, and after T₁ is determined, T₂ₘᵢₙ=T₁+min_{T2-T1}. Wherein he minimum value of T₂−T₁ can be determined based on higher layer parameters, for example, configured for each priority in the higher layer parameters.

Alternatively, T_{A} is a (pre-) configured/(pre-) defined offset, for example, T_{A}=1, so that the sensing starts as early as possible to reduce the latency.

Alternatively, the value of T_{B} includes at least one of the following:
the value of T_{B} is configured by the higher layer/configured by the base station/pre-configured, and further, is configured based on specific parameters including priority and/or remaining PDB; for example, the higher layer configures a corresponding T_{B} value for each priority or several priorities;
the upper bound and/or the lower bound of the value of T_{B} are configured by the higher layer/configured by the base station/pre-configured/pre-defined, and further, are configured based on specific parameters including priority and/or remaining PDB; for example, according to the pre-definition, T_{B} is smaller than or equal to 32 or 31, and the maximum span of time domain corresponding to the reserved resources in the period indicated by SCI is 32 slots; for another example, the higher layer configures a corresponding upper bound and/or lower bound of the value of T_{B} for each priority or several priorities;
the upper bound and/or the lower bound of the value of T_{B} are determined based on the priority and/or the remaining PDB and/or the candidate slots; further, it includes determining according to the position of the earliest slot in the candidate slots and/or the minimum number of candidate slots; for example, if the remaining PDB corresponding to transmission is t_{PDB}, and the minimum number of candidate slots corresponding to transmission is ncandidate, the upper bound of the value of T_{B} is t_{PDB-ncandidate-}T_{proc,2}, where T_{proc,2} corresponds to the processing delay of the UE;
the value of T_{B} or the upper and/or lower bound of the value is determined based on T₁, for example,

T_{B}=T₁, or T_{B}≤T₁, or T_{B}≤T₁≤T_{B}≤T_{proc,1}, where

T_{proc,1}^{SL} corresponds to the processing delay of the UE;
the value of T_{B} or the upper bound of the value is determined based on the candidate resources selected by UE in RSW, for example,

n+T_{B}=t_{y0}^{SL},n+T_{B}≤t_{y0}^{SL}; where T_{proc,1}^{SL} is the first slot of the candidate slots selected

by the UE, and can also be replaced by t_{y0}^{SL+T}_{proc,1}, where T_{proc,1}^{SL} corresponds to the processing delay of the UE.

Alternatively, the value of T₁ includes at least one of the following:
the value of T₁ is configured by the higher layer/configure by the base station/pre-configured, and further is configured based on specific parameters including priority and/or remaining PDB; for example, the higher layer configures a corresponding T₁ value for each priority or several priorities;
the upper and/or lower bound of the value of T₁ are configured by the higher layer/configured by the base station/pre-configured/pre-defined, and further, are configured based on specific parameters including priority and/or remaining PDB; for example, according to the pre-definition, T₁ is greater than or equal to 32 or 31, and the maximum span of time domain corresponding to the reserved resources in the period indicated by SCI is 32 slots; for another example, the higher layer configures a corresponding upper bound and/or lower bound of the value of T₁ for each priority or several priorities;
the upper and/or lower bound of the value of T₁ are determined based on the priority and/or the remaining PDB and/or the candidate slots; further, it includes determining according to the position of the first slot in the candidate slots and/or the minimum number of candidate slots; for example, if the remaining PDB corresponding to transmission is t_{PDB}, and the minimum number of candidate slots corresponding to transmission is ncandidate1, the lower bound of the value of T₁ is t_{PDB_ncanaiaate1-}T_{proc,2};
the upper and/or lower bound of the value of T₁ are determined based on T_{B}, for example, T_{B}=T₁, or T_{B}≤T₁, or T_{B}≤T₁≤T_{B}+T_{proc,1}^{SL}.

Alternatively, the UE determines candidate slots (and/or candidate single-slot resources) in the RSW, including determining all resources in the RSW as candidate slots (and/or candidate single-slot resources). Or, the UE determines a candidate slot set including at least Y candidate slots, and the candidate slots satisfy at least one of the following conditions: (in slot n) CPS-based sensing results are available, and CPS-based sensing can be performed. Further, the UE determines the candidate slots according to at least one of the priority corresponding to transmission, the remaining PDB, and the maximum and/or minimum value of the number of candidate slots. Specific details are similar to those in Embodiment 1.

The UE determines the RSRP threshold Th(pᵢ,pⱼ) used in the sensing procedure (for example, in the resource exclusion step) according to the parameters configured by the higher layer. Specific details are similar to those in Embodiment 1.

The UE initializes the candidate resource set S_{A} to the candidate slots determined in RSW, or to any resources in RSW. The specific details are similar to those in Embodiment 1.

In the above example, similar to the embodiment in which the UE selects resources according to PBPS and CPS, the value of T_{B} or T₁ will affect the number of available at least Y candidate slots.

Alternatively, when the number of slots included in the RSW and/or the number of candidate slots determined in the RSW (or its upper bound, which is not repeated) is smaller than a specific threshold, and/or when the number of candidate resources in the initialized S_{A} (or its upper bound, which is not repeated) is smaller than a specific threshold, and/or when the determined T₂ₘᵢₙ in is smaller than the remaining PDB, the UE adjusts the value of T_{B} or T₁. The method is similar to the Embodiment 1, for example, T_{B}=T_{B}-delta or T_{B}=T_{B}*delta, or T₁=T₁-delta or T₁=T₁*delta, where delta is an offset or scaling percentage.

In addition, since the sensing window monitored in the resource allocation procedure corresponding to a transmission is several consecutive slots, it is possible that even for resource allocation and aperiodic services using only CPS, UE may still find some slots in RSW that already have the sensing results corresponding to CPS. Similar to the Embodiment 1, when there are more than or equal to Y′slots in the RSW/candidate slots selected by the UE, the UE adjusts the value of T_{B} or T₁. The specific method is similar to that in Embodiment 1.

The application provides a method for UE to use partial sensing to select resources, including PBPS and CPS-based methods, so that UE can select the most suitable partial sensing scheme according to service characteristics and types of interference in resource pool, and further reduce power consumption on the premise of ensuring transmission reliability.

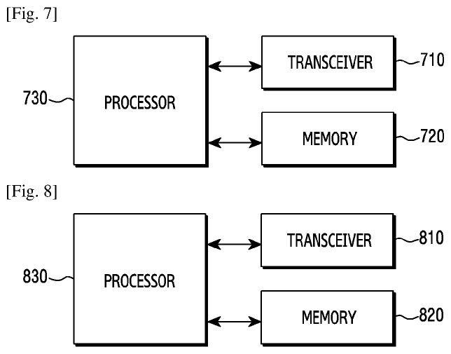

FIG. 7 illustrates a structure of a UE according to an embodiment of the disclosure. As shown in FIG. 7, the UE according to an embodiment may include a transceiver 710, a memory 720, and a processor 730. The transceiver 710, the memory 720, and the processor 730 of the UE may operate according to a communication method of the UE described above. However, the components of the UE are not limited thereto. For example, the UE may include more or fewer components than those described above. In addition, the processor 730, the transceiver 710, and the memory 720 may be implemented as a single chip. Also, the processor 730 may include at least one processor. Furthermore, the UE of FIG. 7 corresponds to the UEs 111-116 of the FIG. 1, respectively.

The transceiver 710 collectively refers to a UE receiver and a UE transmitter, and may transmit/receive a signal to/from a base station or a network entity. The signal transmitted or received to or from the base station or a network entity may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the UE. Also, the memory 720 may store control information or data included in a signal obtained by the UE. The memory 720 may be a storage medium, such as read-only memory (ROM), random access memory (RAM), a hard disk, a CD-ROM, and a DVD, or a combination of storage media.

The processor 730 may control a series of processes such that the UE operates as described above. For example, the transceiver 710 may receive a data signal including a control signal transmitted by the base station or the network entity, and the processor 730 may determine a result of receiving the control signal and the data signal transmitted by the base station or the network entity.

FIG. 8 illustrates a structure of a base station according to an embodiment of the disclosure.

As shown in FIG. 8, the base station according to an embodiment may include a transceiver 810, a memory 820, and a processor 830. The transceiver 810, the memory 820, and the processor 830 of the base station may operate according to a communication method of the base station described above. However, the components of the base station are not limited thereto. For example, the base station may include more or fewer components than those described above. In addition, the processor 830, the transceiver 810, and the memory 820 may be implemented as a single chip. Also, the processor 830 may include at least one processor. Furthermore, the base station of FIG. 8 corresponds to the gNBs 101 to 103 of the FIG. 1, respectively.

The transceiver 810 collectively refers to a base station receiver and a base station transmitter, and may transmit/receive a signal to/from a terminal (UE) or a network entity. The signal transmitted or received to or from the terminal or a network entity may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the base station. Also, the memory 820 may store control information or data included in a signal obtained by the base station. The memory 820 may be a storage medium, such as read-only memory (ROM), random access memory (RAM), a hard disk, a CD-ROM, and a DVD, or a combination of storage media.

The processor 830 may control a series of processes such that the base station operates as described above. For example, the transceiver 810 may receive a data signal including a control signal transmitted by the terminal, and the processor 830 may determine a result of receiving the control signal and the data signal transmitted by the terminal.

There is provided a method performed by a terminal in a wireless communication system, the method comprising determining a resource selection window RSW corresponding to partial sensing, determining a sensing window corresponding to the partial sensing; and determining transmission resources for sidelink transmission based on the partial sensing result.

The RSW comprises at least one of the following: RSW of periodic-based partial sensing PBPS and contiguous partial sensing CPS.

The partial sensing comprises periodic-based partial sensing PBPS and/or contiguous partial sensing CPS, and determining the RSW includes at least one of the following: determining based on the RSW of PBPS; determining based on the sensing window; determining based on a first predetermined threshold.

The method comprises determining a candidate slot set within RSW comprising at least Y candidate slots, and the candidate slots satisfy at least one of the following conditions: PBPS-based sensing results corresponding to the slot are available, CPS-based sensing results corresponding to the slot exist, PBPS-based sensing can be performed on the slot, and CPS-based sensing can be performed on the slot.

The method further comprises determining a candidate slot set within RSW including at least Y candidate slots, wherein the candidate slots are determined based on at least one of the following: the priority corresponding to transmission, the remaining packet delay budget PDB, and the maximum and/or minimum value of the number of the candidate slots.

The first predetermined threshold comprises a threshold based on the number of candidate slots and/or a threshold based on the size of RSW.

If determining transmission resources for the sidelink transmission corresponds to re-evaluation and/or pre-emption, the candidate slot set including at least k candidate slots is determined according to at least one of determining the candidate slots in the set based on at least Y candidate slots selected in the corresponding resource selection/reselection procedure, determining the candidate slots in the set based on the corresponding sensing results of PBPS and/or CPS that already being available when being triggered to select/reselect resources and determining whether a slot can be used as a candidate slot in the set based on whether PBPS-based sensing and/or CPS-based sensing can be performed on the slot in RSW.

The terminal is triggered to perform the resource selection procedure in slot n, the RSW of CPS is [n+T₁, n+T₂], where T₁ and T₂ are offsets, the value of T₁ includes at least one of the following: the value of T₁ is configured by the higher layer/configured by the base station/pre-configured, the upper bound and/or the lower bound of the value of T₁ are configured by the higher layer/configured by the base station/pre-configured/pre-defined, the upper bound and/or lower bound of the value of T₁ are determined based on the priority and/or the remaining PDB and/or the candidate slots and the value of T₁ or the upper and/or lower bound of the value of T1 are determined based on the end position of the sensing window.

The partial sensing includes contiguous partial sensing CPS, the sensing window is determined according to at least one of determining based on at least one of the time point of being triggered to perform resource selection procedure, the selected candidate slot, the time range of reserving resources in the sidelink control information SCI, and the processing delay, determining based on the configured or predefined offset, and/or a second predetermined threshold, and/or the available sensing result and determining based on the value of the configured or predefined offset or the upper bound and/or the lower bound of the value, and/or based on the RSW of CPS.

The second predetermined threshold comprises a threshold based on the number of candidate slots and/or a threshold based on the number of initialized candidate resources.

The terminal is triggered to perform the resource selection procedure in slot n, if the transmission resources determined for sidelink transmission do not correspond to re-evaluation and/or pre-emption, it is determined that the sensing window corresponding to CPS is [n+a,n+c], where a and c are offsets, wherein the value of c includes at least one of the following: the value of c is configured by the higher layer/configured by the base station/pre-configured, the upper bound and/or the lower bound of the value of c are configured by the higher layer/configured by the base station/pre-configured/pre-defined and the upper bound and/or the lower bound of the value of c are determined based on the priority and/or the remaining PDB and/or the candidate slot.

The method comprises determining transmission resources for sidelink transmission from the candidate resource set S_{A}, and the candidate resource set S_{A} is initialized as a set of all candidate slots, and the total number of all candidate slots is X, the value of c is adjusted when X is smaller than a specific threshold, and/or when the number of candidate resources in the initialized S_{A} is smaller than a specific threshold, and/or when there are more than or equal to Y′slots in the determined candidate slots that already have PBPS/CPS-based sensing results.

The terminal is triggered to perform a resource selection procedure in slot n, if the transmission is unpredictable and the transmission resources determined for the sidelink transmission do not correspond to re-evaluation and/or pre-emption, it is determined the sensing window corresponding to CPS is [n+T_{A}, n+T_{B}], where T_{A} and T_{B} are offsets, and the value of T_{B} includes at least one of the following: the value of T_{B} is configured by the higher layer/configured by the base station/pre-configured, the upper bound and/or the lower bound of the value of T_{B} are configured by the higher layer/configured by the base station/pre-configured/predefined, the upper bound and/or lower bound of the value of T_{B} are determined based on priority and/or the remaining PDB and/or the candidate slot, the value of T_{B} or the upper and/or lower bound of the value of T_{B} are determined based on the starting position of the resource selection window RSW and the value of T_{B} or the upper bound of the value of T_{B} are determined based on the candidate resources selected by UE in the resource selection window RSW.

The values of T_{B} and/or T₁ are adjusted when the number of slots included in RSW and/or the number of candidate slots determined in RSW is smaller than a specific threshold, and/or when the number of candidate resources in the initialized candidate resource set S_{A} is smaller than a specific threshold, and/or when there are more than or equal to Y′ slots in the determined RSW/candidate slots that already have CPS-based sensing results.

Thepartial sensing includes periodic-based partial sensing PBPS and/or contiguous partial sensing CPS, and determining the transmission resources for the sidelink transmission includes determining transmission resources for sidelink transmission from the candidate resource set S_{A}, wherein candidate resources that are not used as transmission resources are excluded from the candidate resource set S_{A}, and candidate resources that are not used as transmission resource are excluded by using the CPS-based sensing results, and if PBPS-based sensing results are available, candidate resources that are not used as transmission resources are also excluded by using the PBPS-based sensing results.

The candidate resources that are not used as transmission resources are excluded based on RSRP threshold, and the exclusion includes at least one of the following: sensing results of PBPS and CPS are excluded based on the same or different RSRP thresholds, the available sensing results corresponding to PBPS/CPS when the terminal is triggered to perform the resource selection procedure in slot n and the sensing results corresponding to PBPS/CPS obtained after the slot n are excluded based on the same or different RSRP thresholds and resource selection/reselection, re-evaluation and/or pre-emption are excluded based on the same or different RSRP thresholds.

If the transmission is predictable, and the transmission resources determined for the sidelink transmission do not correspond to re-evaluation and/or pre-emption, the partial sensing includes PBPS and CPS, and the method further comprising determining that the RSW is the RSW of PBPS, determining candidate slots in the RSW based on PBPS and determining that the sensing window is at least a sensing window corresponding to PBPS and a sensing window corresponding to CPS, and the sensing window corresponding to CPS is determined based on at least one of the determined candidate slot, the time range of reserving resources in SCI and the processing delay.

If the transmission is unpredictable, and the transmission resources determined for the sidelink transmission do not correspond to re-evaluation and/or pre-emption, and the partial sensing includes PBPS and/or CPS, the method further comprising determining that the RSW is the RSW of PBPS, determining candidate slots in RSW based on PBPS and/or CPS and determining that the sensing window is at least a sensing window corresponding to PBPS and a sensing window corresponding to CPS, wherein the sensing window corresponding to CPS is determined based on at least one of the time point when the resource selection procedure is triggered, the selected candidate slot, the time range of reserving resources in SCI, and the processing delay.

If the transmission is unpredictable, and the transmission resources determined for the sidelink transmission do not correspond to re-evaluation and/or pre-emption, and the partial sensing includes contiguous partial sensing CPS, the method further comprising determining that the RSW is at least RSW [n+T₁, n+T₂] of CPS, where T₁ is determined according to the configuration and/or according to the sensing window corresponding to CPS, determining candidate slots in RSW, including determining all resources in RSW as candidate slots and determining that the sensing window is at least the sensing window corresponding to CPS, wherein the sensing window corresponding to CPS is determined according to configuration or predefinition and/or according to RSW of CPS.

The transmission being predictable indicates the case in which at least one of the following conditions is satisfied: the transmission of periodic services, the non-zero resource reservation period provided when the physical layer is triggered by the higher layer to perform the resource selection procedure and including the initial transmission and retransmission of data, or including only the initial transmission of the data, or including only the initial transmission and the first N retransmissions of the data, and the transmission is unpredictable to be inconsistent with any other cases in which the transmission is predictable.

The application also discloses an electronic device, which comprises a memory configured to store a computer program; and a processor configured to read the computer program from the memory and run the computer program to realize the above method.

The application also discloses a terminal in a wireless communication system, which comprises a transceiver, and a controller, which is coupled with the transceiver and configured to control to perform the above-mentioned method.

The term “module” may refer to a unit including one of hardware, software, firmware or a combination thereof. The term module can be used interchangeably with the terms unit, logic, logic block, component and circuit. The term “module” can indicate the smallest unit or part of an integrated component. The term “module” may indicate the smallest unit or part that performs one or more functions. The term “module” means a device that can be realized mechanically or electronically. For example, the term “module” may indicate a device including at least one of an application specific integrated circuit (ASIC), a field programmable gate array (FPGA) or a programmable logic array (PLA) that performs certain operations that are known or will be developed in the future.

According to embodiments of the present disclosure, at least a part of a device (e.g., a module or its function) or a method (e.g., an operation) can be implemented as instructions stored in a non-transitory computer readable storage medium, for example, in the form of a programmed circuit. When executed by a processor, the instructions can enable the processor to perform corresponding functions. The non-transitory computer readable storage medium may be, for example, a memory.

Non-transitory computer-readable storage media may include hardware devices such as hard disks, floppy disks and magnetic tapes (e.g., magnetic tapes), optical media such as compact disk read-only memory (ROM)(CD-ROM) and digital versatile disk (DVD), magneto-optical media such as compact disks, ROM, random access memory (RAM), flash memory, etc. Examples of programs can include not only machine language codes, but also high-level language codes that can be run by various computing devices using interpreters. The above-mentioned hardware devices can be configured to operate as one or more software modules to execute the embodiments of the present disclosure, and vice versa.

Circuits or programming circuits according to various embodiments of the present disclosure may include at least one or more of the aforementioned components, omit some of them, or also include other additional components. Operations performed by circuits, programmed circuits, or other components according to various embodiments of the present disclosure may be performed sequentially, simultaneously, repeatedly, or heuristically. In addition, some operations may be performed in a different order, or omitted, or include other additional operations.

The embodiments of the present disclosure are described to facilitate understanding of the present disclosure, but are not intended to limit the scope of the present disclosure. Therefore, the scope of the present disclosure should be interpreted to include all changes or various embodiments based on the scope of the present disclosure defined by the appended claims and their equivalents.

1-15. (canceled)

16. A method performed by a user equipment (UE) in a wireless communication system, the method comprising:
in case that a physical sidelink shared channel (PSSCH) resource selection for a periodic transmission is triggered, identifying candidate slots for the periodic transmission based on first information on a minimum number of the candidate slots; and
performing a contiguous partial sensing (CPS) within a sensing window which starts in a slot which is earlier than a first slot of the candidate slots by a first number of slots and ends in a slot which is earlier than the first slot of the candidate slots by a second number of slots.

17. The method of claim 16, further comprising:
identifying a PSSCH resource to be excluded based on a physical sidelink control channel (PSCCH) and reference signal received power (RSRP) higher than a threshold within the sensing window.

18. The method of claim 16, wherein the first number is configured with the UE, and
wherein the second number is based on a processing delay.

19. The method of claim 16, wherein the first number corresponds to 31.

20. The method of claim 16, wherein, in case that the PSSCH resource selection for the periodic transmission is triggered, a period-based partial sensing (PBPS) is performed with the CPS.

21. The method of claim 16, further comprising:
in case that a PSSCH resource selection for an aperiodic transmission is triggered, identifying candidate slots for the aperiodic transmission based on second information on a minimum number of the candidate slots for the aperiodic transmission.

22. The method of claim 21, further comprising:
performing a CPS based on the candidate slots for the aperiodic transmission.

23. The method of claim 16, wherein a number of the candidate slots exceeds or is equal to the minimum number of the candidate slots for the periodic transmission.

24. A user equipment (UE) in a wireless communication system, the UE comprising:
a transceiver; and
a controller coupled with the transceiver and configured to:
in case that a physical sidelink shared channel (PSSCH) resource selection for a periodic transmission is triggered, identify candidate slots for the periodic transmission based on first information on a minimum number of the candidate slots, and
perform a contiguous partial sensing (CPS) within a sensing window which starts in a slot which is earlier than a first slot of the candidate slots by a first number of slots and ends in a slot which is earlier than the first slot of the candidate slots by a second number of slots.

25. The UE of claim 24, wherein the controller is further configured to:
identify a PSSCH resource to be excluded based on a physical sidelink control channel (PSCCH) and reference signal received power (RSRP) higher than a threshold within the sensing window.

26. The UE of claim 24, wherein the first number is configured with the UE, and
wherein the second number is based on a processing delay.

27. The UE of claim 24, wherein the first number corresponds to 31.

28. The UE of claim 24, wherein, in case that the PSSCH resource selection for the periodic transmission is triggered, a period-based partial sensing (PBPS) is performed with the CPS.

29. The UE of claim 24, wherein the controller is further configured to:
in case that a PSSCH resource selection for an aperiodic transmission is triggered, identify candidate slots for the aperiodic transmission based on second information on a minimum number of the candidate slots for the aperiodic transmission.

30. The UE of claim 29, wherein the controller is further configured to:
perform a CPS based on the candidate slots for the aperiodic transmission.
